(19) United States
(12) Patent Application Publication
(10) Pub. No.: US 2011/0214930 A1
(43) Pub. Date: Sep. 8, 2011

(54) METHOD AND SYSTEM FOR CONTROLLING THE TEMPERATURE OF VEHICLE BATTERIES

(75) Inventors: Daniel Carrington Betts, Parkland, FL (US); Thomas J. Pavlik, Riviera Beach, FL (US); Timothy C. Scalzo, Westfield, IN (US); Matthew Graham, West Palm Beach, FL (US); Naoki Ota, Fishers, IN (US)

(73) Assignee: ENERFUEL, INC., West Palm Beach, FL (US)

(21) Appl. No.: 13/043,051

(22) Filed: Mar. 8, 2011

Related U.S. Application Data
(60) Provisional application No. 61/311,691, filed on Mar. 8, 2010.

(51) Int. Cl. B60L 11/18; H01M 10/50

(52) U.S. Cl. 180/65.1; 429/62

(57) ABSTRACT

Systems and methods for controlling a temperature of a plurality of batteries of a vehicle are described. The systems and methods may transfer heat from a fuel cell system to the plurality of batteries of the vehicle. The heat produced by the fuel cell system may be transferred to the plurality of batteries through at least one heat transfer system.

### RELATED APPLICATIONS

This application claims the benefit of U.S. Provisional Patent Application Ser. No. 61/311,691, filed Mar. 8, 2010, titled METHOD AND SYSTEM FOR MAINTAINING OR INCREASING THE TEMPERATURE OF ELECTRIC VEHICLE BATTERIES, docket 10110-24, the disclosure of which is expressly incorporated by reference herein in its entirety.

### FIELD

The invention relates in general to methods and systems for controlling the temperature of batteries and, more particularly, to methods and systems for controlling the temperature of vehicle batteries.

### BACKGROUND

The performance of batteries is dependent on temperature. At low temperatures, the rate of discharge and recharge of the batteries is reduced. For electric vehicles that rely on batteries for propulsion, this may manifest itself as a drop in vehicle performance.

### SUMMARY

In an exemplary embodiment of the present disclosure, a system for controlling the temperature of a vehicle battery is disclosed. The system includes a fuel cell system which produces both heat and electrical energy. In one example, the heat produced by the fuel cell system is used to maintain or increase the temperature of the vehicle battery. In another example, the electrical energy produced by the fuel cell system is used to maintain or increase the temperature of the vehicle battery. In a further example, the heat produced by the effluent of the fuel cell system is used to maintain or increase the temperature of the vehicle battery. In yet a further example, at least two of the heat produced by the fuel cell system, the heat produced by the effluent of the fuel cell system, and the electrical energy produced by the fuel cell system are used to maintain or increase the temperature of the vehicle battery.

In another exemplary embodiment of the disclosure, a vehicle is provided. The vehicle comprising: a plurality of ground engaging members; a frame supported by the plurality of ground engaging members; a battery system including a plurality of batteries supported by the frame; a fuel cell system supported by the frame; and a vehicle propulsion system supported by the plurality of ground engaging members. The vehicle propulsion system coupling the battery system to at least one of the plurality of ground engaging members. The vehicle further comprising a heat transfer system supported by the frame. The heat transfer system transferring heat produced by the fuel cell system to the battery system to warm the plurality of batteries when a temperature of the plurality of batteries is below a desired temperature.

In yet another exemplary embodiment of the disclosure, a method for controlling a temperature of a plurality of batteries is provided. The method comprising the steps of: monitoring a temperature associated with the plurality of batteries; and transferring heat from a fuel cell system to the plurality of batteries when a temperature of the plurality of batteries is below a desired temperature.

In a further exemplary embodiment of the disclosure, a method for controlling a temperature of a plurality of batteries is provided. The method comprising the steps of: receiving an indication of a future use; monitoring a temperature associated with the plurality of batteries; determining a time period in advance of the future use needed to warm the plurality of batteries to a desired temperature; and during the time period transferring heat to the plurality of batteries to warm the plurality of batteries while the temperature of the plurality of batteries is below the desired temperature.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 illustrates an exemplary vehicle;

FIG. 2 illustrates a diagrammatic view of the vehicle of FIG. 1 including a vehicle battery system and a fuel cell system;

FIG. 3 illustrates a diagrammatic view of the vehicle of FIG. 1 including a vehicle battery system and a fuel cell system including a hydrogen tank;

FIG. 4 illustrates a diagrammatic view of the vehicle of FIG. 1 including a vehicle battery system and a fuel cell system including a fuel processor and a catalytic oxidizer;

FIG. 5 illustrates an exemplary processing sequence of a controller of the vehicle of FIG. 1;

FIG. 6 illustrates an exemplary heat transfer system for transferring heat from a fuel cell assembly to a battery assembly of the vehicle of FIG. 1;

FIG. 7 illustrates exemplary heat transfer features on a fuel cell stack of the fuel cell assembly of FIG. 6;

FIG. 8 illustrates another exemplary heat transfer system for transferring heat from a fuel cell assembly to a battery assembly of the vehicle of FIG. 1;

FIG. 9 illustrates an exemplary fuel cell stack of the fuel cell assembly of FIG. 8;

FIGS. 10A and 10B illustrate first and second faces of a first bipolar plate of the fuel cell stack of FIG. 9;

FIGS. 11A and 11B illustrate first and second faces of a second bipolar plate of the fuel cell stack of FIG. 9;

FIG. 12 illustrates an exemplary heat transfer system for transferring heat from a fuel cell assembly to a battery assembly of the vehicle of FIG. 1;

FIG. 13 illustrates an exemplary heat transfer system for transferring heat from a fuel cell assembly to a battery assembly of the vehicle of FIG. 1;

FIG. 14 illustrates an exemplary processing sequence of a controller of the vehicle of FIG. 1;

FIGS. 15A-15C illustrate a direct conduction heat transfer system for transferring heat from a fuel cell assembly to a battery assembly of the vehicle of FIG. 1;

FIG. 16 illustrates a passive heat transfer system for transferring heat from a fuel cell assembly to a battery assembly of the vehicle of FIG. 1;

FIG. 17 illustrates a heat transfer system for transferring heat from a fuel cell assembly to a battery assembly of the vehicle of FIG. 1 including the use of an effluent of the fuel cell assembly;

FIG. 18 illustrates an exemplary processing sequence of a controller of the vehicle of FIG. 1 for the heat transfer system of FIG. 17;

FIG. 19 illustrates a heat transfer system for transferring heat from a fuel cell assembly to a battery assembly of the vehicle of FIG. 1 including the use of an electrical connection between a fuel cell assembly to a battery assembly of the vehicle of FIG. 1;

FIG. 20 illustrates an exemplary processing sequence of a controller of the vehicle of FIG. 1 for the heat transfer system of FIG. 19;

FIG. 21 illustrates the vehicle of FIG. 1 including a user interface;

FIG. 22 illustrates the controller of the vehicle of FIG. 1 communicating with a remote device over a network; and

FIGS. 23-25 illustrate exemplary processing sequences of a controller of the vehicle of FIG. 1.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings. While the present invention primarily involves the temperature control of vehicle batteries, it should be understood, that the invention may have application to other devices which receive power from batteries.

A fuel cell onboard a vehicle may be used to recharge electric vehicle batteries when the vehicle is parked or while driving. Further, the fuel cell may be used to heat up the batteries when the temperature associated with the batteries drops below a certain limit or to maintain a temperature associated with the batteries above a certain threshold.

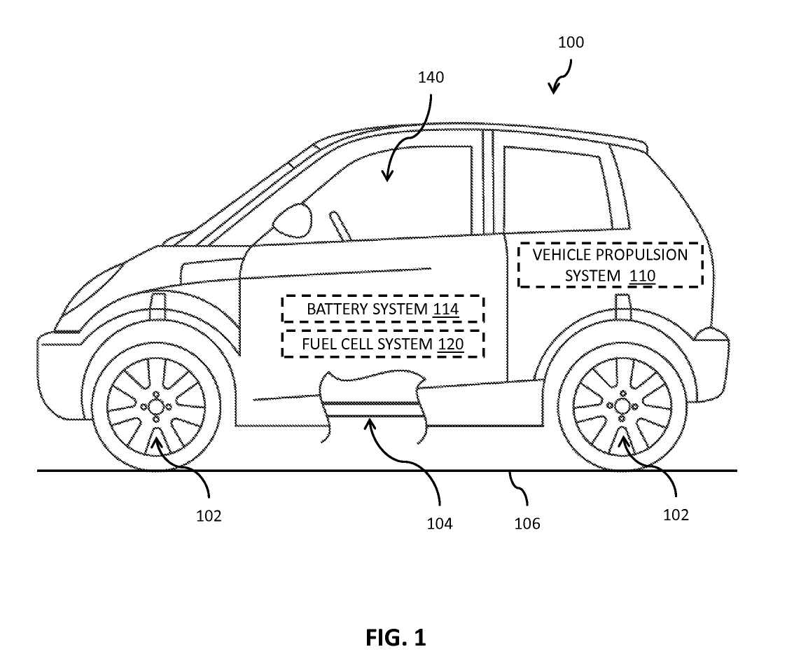

Referring to FIG. 1, an exemplary vehicle 100 is shown. Vehicle 100 includes a plurality of ground engaging members 102, illustratively wheels and associated tires. A frame 104 of vehicle 100 is supported above the ground 106 by the ground engaging members 102. A vehicle propulsion system 110 is also supported by ground engaging members 102 and is operatively coupled to at least one of ground engaging members 102 to power the movement of vehicle 100 relative to ground 106. Vehicle propulsion system 110 may be supported by frame 104.

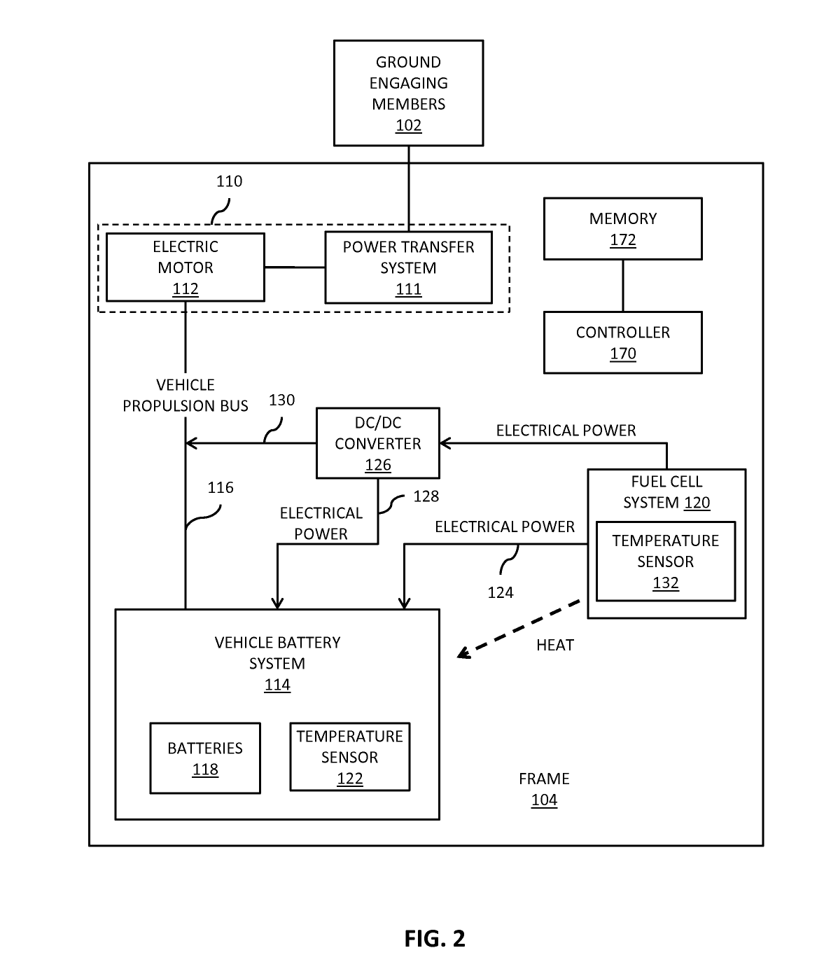

Referring to FIG. 2, in one embodiment, vehicle 100 includes an electric motor 112 which receives electrical energy from a battery system 114 over a vehicle propulsion bus 116. Electric motor 112 is operatively coupled to one or more ground engaging members 102 through a power transfer system 111. Exemplary power transfer systems 111 include transmissions and drive shafts. Battery system 114 includes a plurality of batteries 118. Exemplary batteries 118 include lithium ion batteries, lead acid batteries, NiCd batteries, NiMH batteries, molten salt batteries, and other suitable battery chemistries. An exemplary molten salt battery is the ZEBRA brand battery available from FZ SoNick located at Via Laveggio, 15 6855 Stabio in Switzerland. In one embodiment, the plurality of batteries 118 are provided in one or more battery packs or assemblies. Exemplary batteries and battery assemblies are provided in US Published Patent Application No. US20080193830A1, filed Apr. 16, 2008, titled BATTERY ASSEMBLY WITH TEMPERATURE CONTROL DEVICE; US Published Patent Application No. US20080226969A1, filed Mar. 13, 2008, titled BATTERY PACK ASSEMBLY WITH INTEGRATED HEATER; US Published Patent Application No. US20080299448A1, filed Nov. 2, 2007, titled BATTERY UNIT WITH TEMPERATURE CONTROL DEVICE; and US Published Patent Application No. US20100273042A1, filed Mar. 13, 2008, titled BATTERY ASSEMBLY WITH TEMPERATURE CONTROL DEVICE, the disclosures of which are expressly incorporated by reference herein in their entirety.

In the illustrated embodiment, battery system 114 provides at least a portion of the motive power for vehicle 100. In one embodiment, vehicle propulsion system 110 converts the power provided by batteries 118 to AC to drive an AC electric motor. In one example, battery system 114 provides at least about 200 V to vehicle propulsion system 110. In one example, battery system 114 provides up to about 400 V to vehicle propulsion system 110. In one example, battery system 114 provides in the range of about 240 V to about 400 to vehicle propulsion system 110. In one embodiment, vehicle propulsion system 110 operates at between about 35 to about 100 kW. In one embodiment, vehicle propulsion system 110 operates at up to about 200 kW. In one embodiment, vehicle propulsion system 110 operates at between about 35 kW to about 200 kW.

As illustrated in FIG. 2, vehicle 100 further includes a fuel cell system 120. Exemplary fuel cell systems include solid oxide, phosphoric acid, proton exchange membrane (PEM), and high temperature PEM. Fuel cell system 120 provides electrical energy when fuel cell system 120 is active. The electrical power produced by fuel cell system 120 may be coupled directly to battery system 114 as illustrated by connection 124, may be coupled to battery system 114 through a voltage control device 126 (illustratively a DC-DC converter) as illustrated by connection 128, and may be coupled to vehicle propulsion bus 116 through voltage control device 126 as illustrated by connection 130. When coupled to vehicle propulsion bus 116, fuel cell system 120 provides at least a part of the motive force for vehicle 100.

In addition to electrical power, fuel cell system 120 further produces heat due to the chemical reactions being carried out by fuel cell system 120. In one embodiment, at least a portion of this heat is used, either directly or indirectly, to control the temperature of the batteries 118 of the battery system 114. The heat produced by fuel cell system 120 during operation is transferred to the battery system 114 via any suitable liquid or gaseous heat transfer fluid or by thermal conduction. The heat produced by the fuel cell system 120 may be transferred by a passive heat transfer system or an active heat transfer system.

When the operating temperature of the fuel cell is at or above a desired temperature of batteries 118, the heat from the fuel cell may be used to warm the batteries. The operating temperatures of exemplary fuel cells are provided in Table I below. Further, the operating temperatures of exemplary battery chemistries are also provided in Table II below. In one embodiment, the desired temperature of the batteries 118 is generally within the operating temperature of the batteries. The larger the differential between the operating temperature of a selected fuel cell and the desired temperature of a selected battery chemistry, the shorter the warming time of the batteries 118. In one embodiment, it is preferred to use a fuel cell system 120 that operates at temperatures above about twice the desired temperature of the batteries 118.

Exemplary fuel cells include solid oxide fuel cell having an operating temperature in the range of about 500° C. to about 1000° C., phosphoric acid fuel cells having an operating temperature in the range of about 150° C. to about 200° C., proton exchange membranes (PEM) having an operating temperature in the range of about 60° C. to about 80° C., high temperature PEM having an operating temperature in the range of about 140° C. to about 190° C., and other suitable fuel cells.

Electrically connecting fuel cell system 120 to battery system 114 may be used to both trickle charge batteries 118 and control the temperature of batteries 118 of battery system 114. Trickle charging batteries 118 of battery system 114 also protects the battery life. It is noted that trickle charging may be used separately or in combination with the additional heat transfer systems disclosed herein to maintain the temperature of batteries 118 of battery system 114.

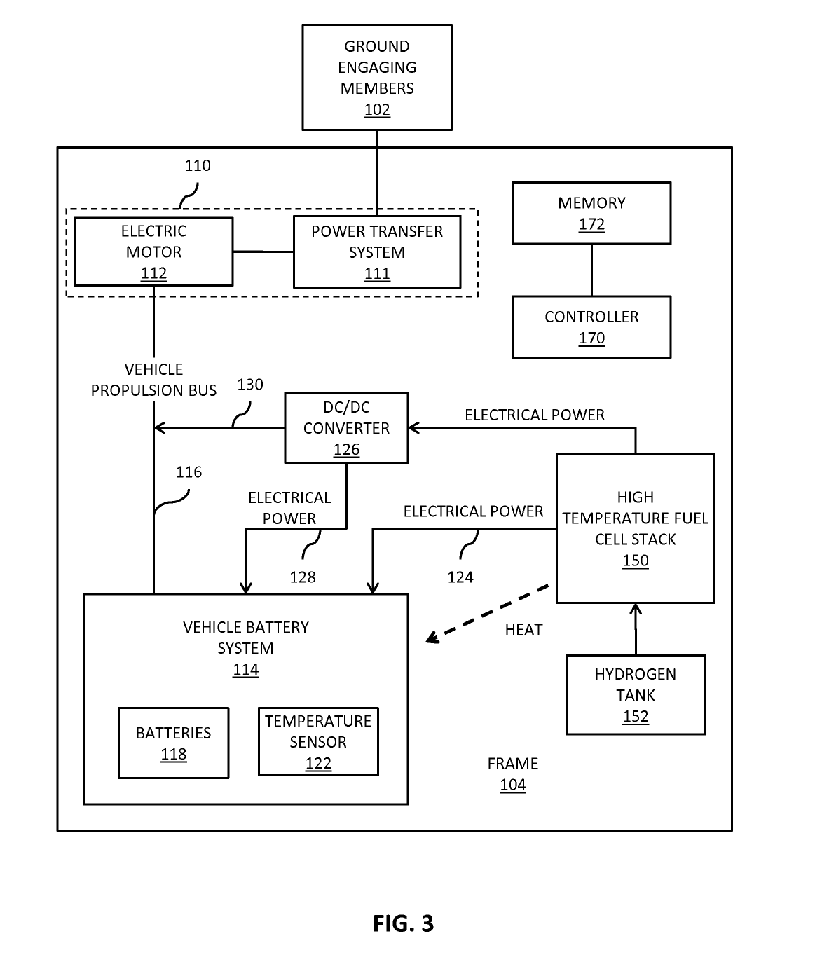

Referring to FIG. 3, an exemplary fuel cell system is shown including a high temperature fuel cell stack 150 and a hydrogen storage tank 152 storing hydrogen gas. Heat production is a natural product of the irreversible electrochemical reaction of the high temperature fuel cell stack 150. This heat should be removed from high temperature fuel cell stack 150 in order to prevent overheating of high temperature fuel cell stack 150. This heat may be dissipated to the environment or used to control the temperature of batteries 118 of battery system 114. In this embodiment, the heat generated by high temperature fuel cell stack 150 is used to warm batteries 118 of battery system 114 or maintain their temperature.

Various systems and methods for transferring heat from fuel cell system 120 to batteries 118 of battery system 114, such as from high temperature fuel cell stack 150, are disclosed herein. In one embodiment, the heat produced by high temperature fuel cell stack 150 is transferred to batteries 118 of battery system 114 via a heat transfer fluid through a coolant loop. The conduits of the coolant loop may contact the batteries, contact heat sink elements coupled to the batteries, or simply pass in close proximity to at least one of the batteries and heat sink elements coupled to the batteries. Exemplary heat transfer fluids include liquid fluids and gaseous fluids. In one embodiment, the heat produced by high temperature fuel cell stack 150 is transferred to the batteries 118 of battery system 114 through convection via a gaseous heat transfer fluid by directing air, used for cooling the fuel cell stack, to battery system 114. The convective heat transfer fluid may also be liquid. In one embodiment, the heat produced by high temperature fuel cell stack 150 is transferred to battery system 114 via thermal conduction.

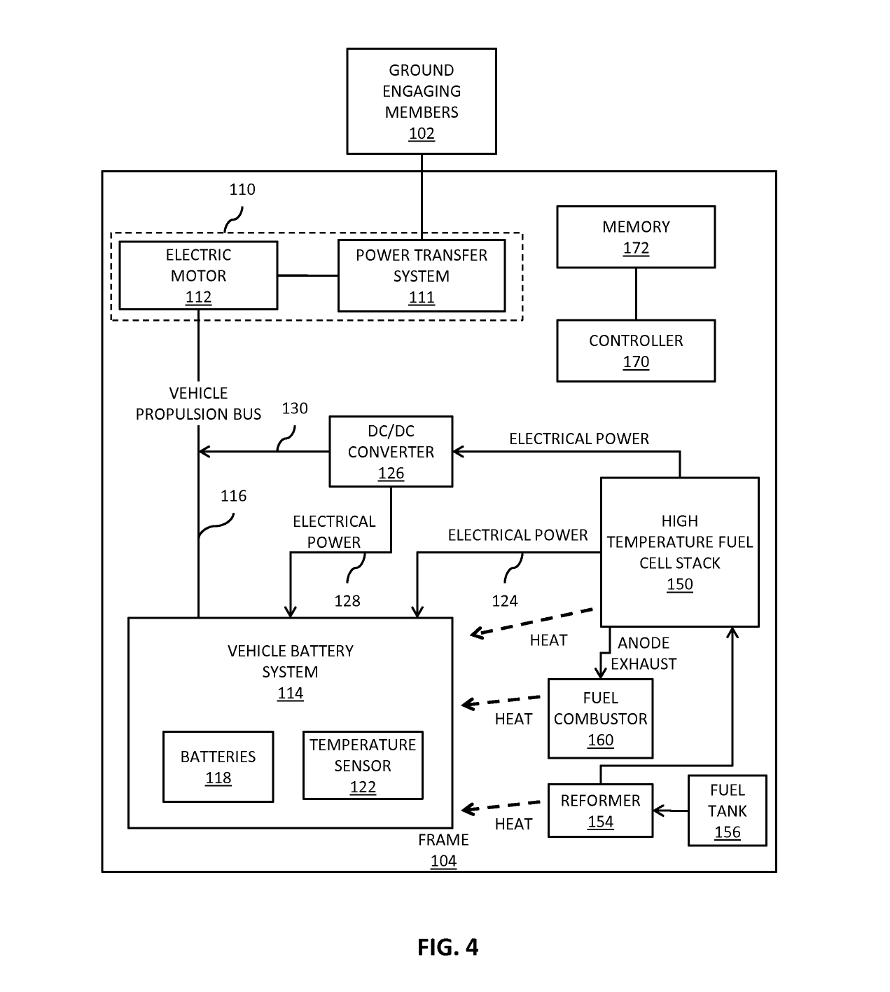

Referring to FIG. 4, an exemplary fuel cell system is shown including a high temperature fuel cell stack 150 and a fuel processor 154, illustratively a reformer, which produces hydrogen from a fuel stored in a fuel storage tank 156. The reformation process produces heat by oxidizing a portion of the fuel being reformed. The exemplary fuel cell system further includes a fuel combustor 160 which burns the anode exhaust from the high temperature fuel cell stack 150. The fuel combustor 160, or a separate fuel combustor, may also burn the cathode exhaust from high temperature fuel cell stack 150. Exemplary types of fuel combustors 160 include spark-ignited burners, compression devices, and catalytic oxidizers. The heat provided by fuel combustor 160 may be transferred to battery system 114 to increase the temperature associated with batteries 118. A fuel combustor 160 may be used to oxidize excess hydrogen and other gases leaving the anode chambers of high temperature fuel cell stack 150 and excess oxygen and other gases leaving the cathode chambers of high temperature fuel cell stack 150, with a reduced or zero emission of toxic gases.

High temperature fuel cell stack 150, fuel processor 154, and fuel combustor 160 all produce heat during operation. This heat should be removed from high temperature fuel cell stack 150, fuel processor 154, and fuel combustor 160 in order to prevent overheating of the respective high temperature fuel cell stack 150, fuel processor 154, and fuel combustor 160. This heat may be dissipated to the environment or used to control the temperature of batteries 118 or other components of battery system 114. In this embodiment, the heat generated by one or more of high temperature fuel cell stack 150, fuel processor 154, and fuel combustor 160 may be used to warm batteries 118 of battery system 114 or maintain their temperature.

Various systems and methods for transferring heat from fuel cell system 120 to batteries 118 of battery system 114, such as from one or more of high temperature fuel cell stack 150, fuel processor 154, and fuel combustor 160, are disclosed herein. In one embodiment, the heat produced by one or more of high temperature fuel cell stack 150, fuel processor 154, and fuel combustor 160 may be transferred to batteries 118 of battery system 114 via a liquid heat transfer fluid through a coolant loop. In one embodiment, the heat produced by one or more of high temperature fuel cell stack 150, fuel processor 154, and fuel combustor 160 is transferred to the batteries 118 of battery system 114 via a gaseous heat transfer fluid by directing air used for cooling the one or more of high temperature fuel cell stack 150, fuel processor 154, and fuel combustor 160 to battery system 114. In one embodiment, the heat produced by one or more of high temperature fuel cell stack 150, fuel processor 154, and fuel combustor 160 is transferred to battery system 114 via thermal conduction. In addition, in one embodiment, the effluent of fuel combustor 160 is used to warm batteries 118 of battery system 114 or maintain their temperature. To control the temperature of the catalytic oxidizer effluent, a fan or blower may be used to dilute the effluent.

Returning to FIG. 2, vehicle 100 includes a controller 170 which controls the temperature associated with the batteries 118 of battery system 114. In one embodiment, controller 170 is part of a battery management system of battery system 114 which controls the operation of battery system 114. In one embodiment, controller 170 is part of a fuel cell management system of fuel cell system 120 which controls the operation of fuel cell system 120. In one embodiment, controller 170 is a vehicle controller which generally controls the overall operation of vehicle 100. Although represented as a single block, controller 170 may be comprised of multiple components which together carry out one or more of the processing sequences described herein.

In one embodiment, controller 170 has access to an associated memory 172. The memory 172 includes computer readable media. Computer-readable media may be any available media that may be accessed by one or more components of controller 170 and may include both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by controller 170. In one embodiment, memory 172 may include software which when executed by controller 170 performs one or more of the processing sequences described herein. Further, memory 172 may include space for the storage of data related to vehicle 100. However, memory 172 is not limited to memory associated with the execution of the processing sequences and memory associated with the storage of data. The processing sequences described herein may be implemented in hardware or software, or a combination of hardware and software. In one embodiment, controller 170 includes additional hardware, software, or combination thereof to allow controller 170 to interact with various input devices, output devices, and networks.

Controller 170 monitors or otherwise receives an indication from a temperature sensor 122 associated with the battery system 114. Temperature sensor 122 is positioned to monitor a temperature which is representative of a temperature of batteries 118. In one embodiment, multiple temperature sensors 122 are provided. Exemplary temperature sensors 122 include thermocouples and other devices which provide an indication of a temperature. Temperature sensor 122 may be affixed to one of batteries 118, positioned to monitor a region proximate to batteries 118, or otherwise positioned to provide an indication of the temperature of batteries 118.

In one embodiment, controller 170 also monitors or otherwise receives an indication from a temperature sensor 132 associated with the fuel cell system 120. Temperature sensor 132 is positioned to monitor a temperature which is representative of a temperature of fuel cell system 120. In the embodiment shown in FIG. 3, temperature sensor 132 monitors a temperature which is representative of high temperature fuel cell stack 150. In the embodiment shown in FIG. 4, temperature sensor 132 monitors a temperature which is representative of at least one of high temperature fuel cell stack 150, fuel processor 154, and fuel combustor 160. In one embodiment, multiple temperature sensors 132 are provided. Temperature sensor 132 may be affixed to one of high temperature fuel cell stack 150, fuel processor 154, and fuel combustor 160, positioned to monitor a region proximate to one of high temperature fuel cell stack 150, fuel processor 154, and fuel combustor 160, or otherwise positioned to provide an indication of the temperature of one of high temperature fuel cell stack 150, fuel processor 154, and fuel combustor 160.

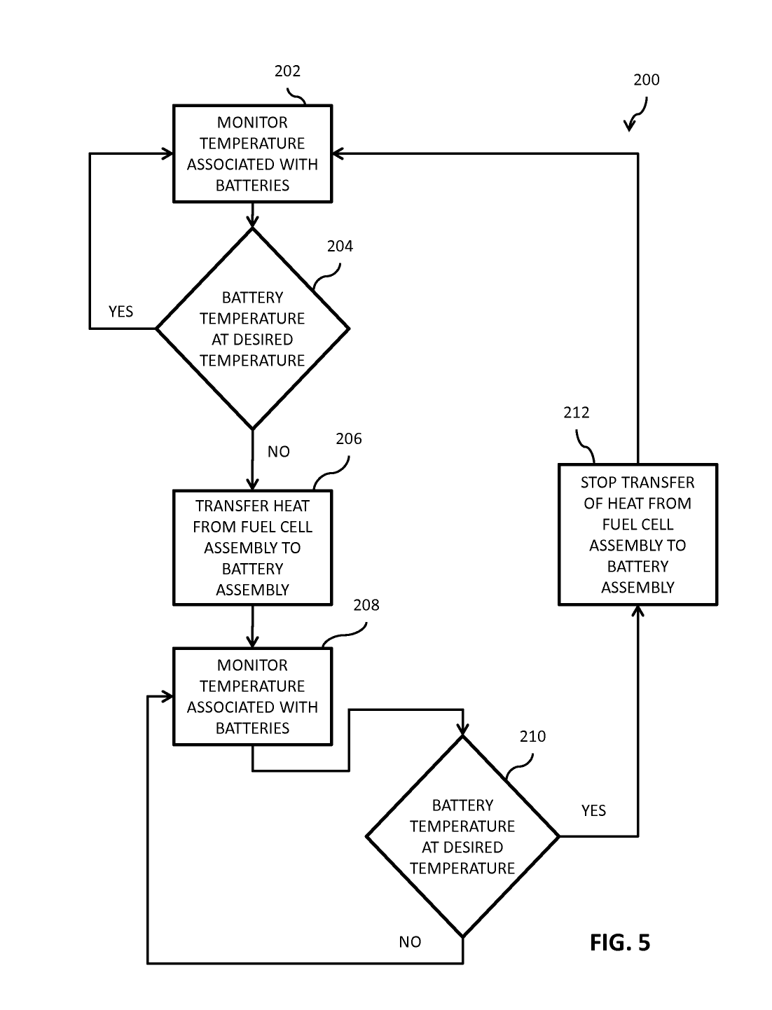

Referring to FIG. 5, an exemplary processing sequence 200 of controller 170 is illustrated. Controller 170 monitors the temperature associated with batteries 118, as represented by block 202. In one embodiment, controller 170 monitors the temperature of temperature sensor 122. Controller 170 determines if the current battery temperature is at a desired temperature, as represented by block 204. In one embodiment, the current battery temperature is at the desired temperature when it is above a threshold temperature. In one example, batteries 118 are lithium ion batteries and exemplary threshold temperatures include about 25° C., about 30° C., about 40° C., and about 50° C. In one example, batteries 118 are molten salt batteries and exemplary threshold temperatures include about 250° C., about 300° C., and about 400° C. In one example, batteries 118 are lead acid batteries and exemplary threshold temperatures include about 10° C. and about 20° C. In one example, batteries 118 are NiMH batteries and exemplary threshold temperatures include about 20° C. and about 40° C. In one embodiment, the current battery temperature is at the desired temperature when it is within a first temperature range. In one example, batteries 118 are lithium ion batteries and exemplary first temperature ranges include from about 25° C. to about 50° C., from about 30° C. to about 40° C., and from about 30° C. to about 50° C. In one example, batteries 118 are molten salt batteries and exemplary first temperature ranges include from about 250° C. to about 400° C., from about 250° C. to about 700° C., and from about 300° C. to about 400° C. In one example, batteries 118 are lead acid batteries and an exemplary first temperature range is from about 10° C. to about 20° C. In one example, batteries 118 are NiMH batteries and an exemplary first temperature range is from about 20° C. to about 40° C.

If the current battery temperature is lower than the desired temperature, controller 170 causes heat to be transferred from fuel cell system 120 to battery system 114 to raise the temperature associated with batteries 118 of battery system 114, as represented by block 206. In one embodiment, controller 170 activates fuel cell system 120. In one embodiment, controller 170 controls a heat transfer system to transfer heat from an activated fuel cell system 120 to battery system 114. Exemplary heat transfer systems are described herein.

Controller 170 continues to monitor the temperature associated with batteries 118 of battery system 114, as represented by block 208. Controller 170 determines if the temperature associated with batteries 118 of battery system 114 is at the desired temperature, as represented by block 210. In one embodiment, the current battery temperature is at the desired temperature when it is above a threshold temperature. In one example, batteries 118 are lithium ion batteries and exemplary threshold temperatures include about 25° C., about 30° C., about 40° C., and about 50° C. In one example, batteries 118 are molten salt batteries and exemplary threshold temperatures include about 250° C., about 300° C., and about 400° C. In one example, batteries 118 are lead acid batteries and exemplary threshold temperatures include about 10° C. and about 20° C. In one example, batteries 118 are NiMH batteries and exemplary threshold temperatures include about 20° C. and about 40° C. In one embodiment, the current battery temperature is at the desired temperature when it is within a first temperature range. In one example, batteries 118 are lithium ion batteries and exemplary first temperature ranges include from about 25° C. to about 50° C., from about 30° C. to about 40° C., and from about 30° C. to about 50° C. In one example, batteries 118 are molten salt batteries and exemplary first temperature ranges include from about 250° C. to about 400° C., from about 250° C. to about 700° C., and from about 300° C. to about 400° C. In one example, batteries 118 are lead acid batteries and an exemplary first temperature range is from about 10° C. to about 20° C. In one example, batteries 118 are NiMH batteries and an exemplary first temperature range is from about 20° C. to about 40° C.

When the current battery temperature is at the desired temperature, controller 170 stops the transfer of heat from fuel cell system 120 to battery system 114, as represented by block 212. In one embodiment, controller 170 deactivates fuel cell system 120. In one embodiment, controller 170 controls a heat transfer system to stop the transfer of heat from an activated fuel cell system 120 to battery system 114. In this embodiment, fuel cell system 120 may provide power to trickle charge batteries 118 of battery system 114, to provide power to vehicle propulsion bus 116, or provide power to one or more auxiliary devices of vehicle 100. Exemplary auxiliary devices include an air conditioning system to cool a passenger compartment 140, a heating system to warm passenger compartment 140, DC appliances, including radios, televisions, computers, communication devices, and other devices onboard vehicle 100 which require electrical power.

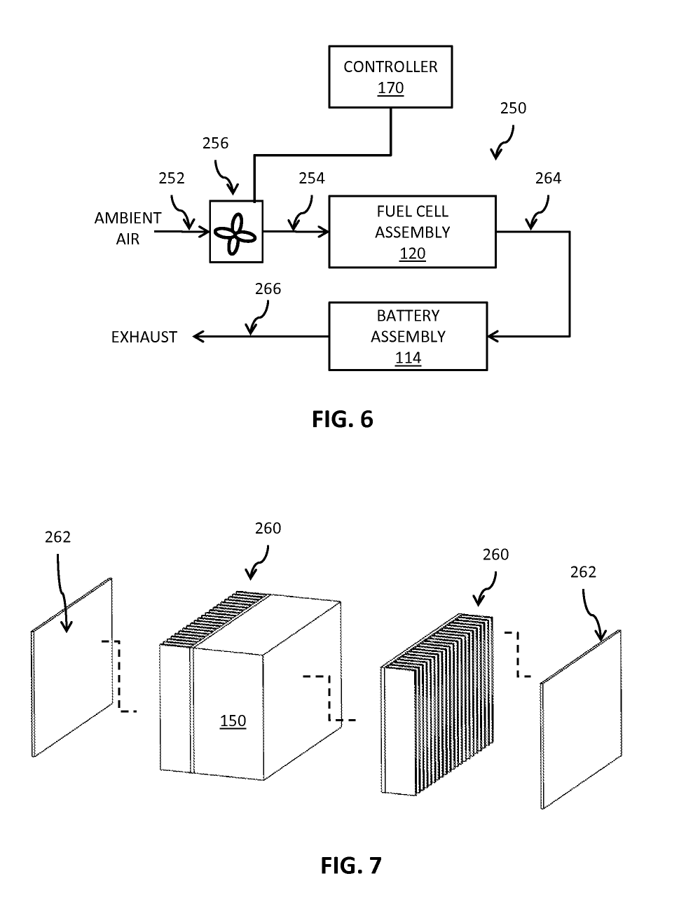

Referring to FIG. 6, an exemplary heat transfer system 250 is represented. A gaseous heat transfer fluid, ambient air, enters an inlet fluid conduit 252 and is forced to fuel cell system 120 through a fluid conduit 254 by a fan 256 or other air directing device. Referring to FIG. 7, a portion of fuel cell system 120, illustratively high temperature fuel cell stack 150, includes fins 260 attached to one or more surfaces. Plates 262 are coupled to fins 260 to provide an enclosed fluid path which is in fluid communication with fluid conduit 254 to receive the air from fluid conduit 254. While passing through the enclosed fluid path the air takes on heat from fuel cell system 120. The warmed air exits the enclosed fluid path of fuel cell system 120 and enters a fluid conduit 264. Fluid conduit 264 is in fluid communication with an interior of battery system 114. The air passes over heat transfer surfaces coupled to batteries 118. Heat is transferred to the heat transfer surfaces associated with batteries 118 and heats up batteries 118. In one embodiment, the heat transfer surfaces associated with batteries 118 includes fins. Exemplary fins are disclosed in US Published Patent Application No. US20080193830A1, filed Apr. 16, 2008, titled BATTERY ASSEMBLY WITH TEMPERATURE CONTROL DEVICE, the disclosure of which is expressly incorporated by reference herein in its entirety. Other types of heat transfer features may be used to increase the surface area of the heat transfer surfaces associated with batteries 118. The air exits battery system 114 and is exhausted through an exhaust fluid conduit 266.

Returning to FIG. 6, the operation of fan 256 is controlled by controller 170. When controller 170 determines that heat is to be transferred from fuel cell system 120 to battery system 114, controller 170 activates fan 256 or otherwise adjusts the operation of fan 256 or other components of heat transfer system 250, such as valves or diverters. Further, controller 170 may adjust a speed or other parameter of fan 256 or other components of heat transfer system 250 to control a rate of heat transfer from fuel cell system 120 to battery system 114. When controller 170 determines that heat is no longer needed to be transferred from fuel cell system 120 to battery system 114 to alter the temperature associated with batteries 118, controller 170 deactivates fan 256 or otherwise adjusts the operation of fan 256 or other components of heat transfer system 250, such as valves or diverters.

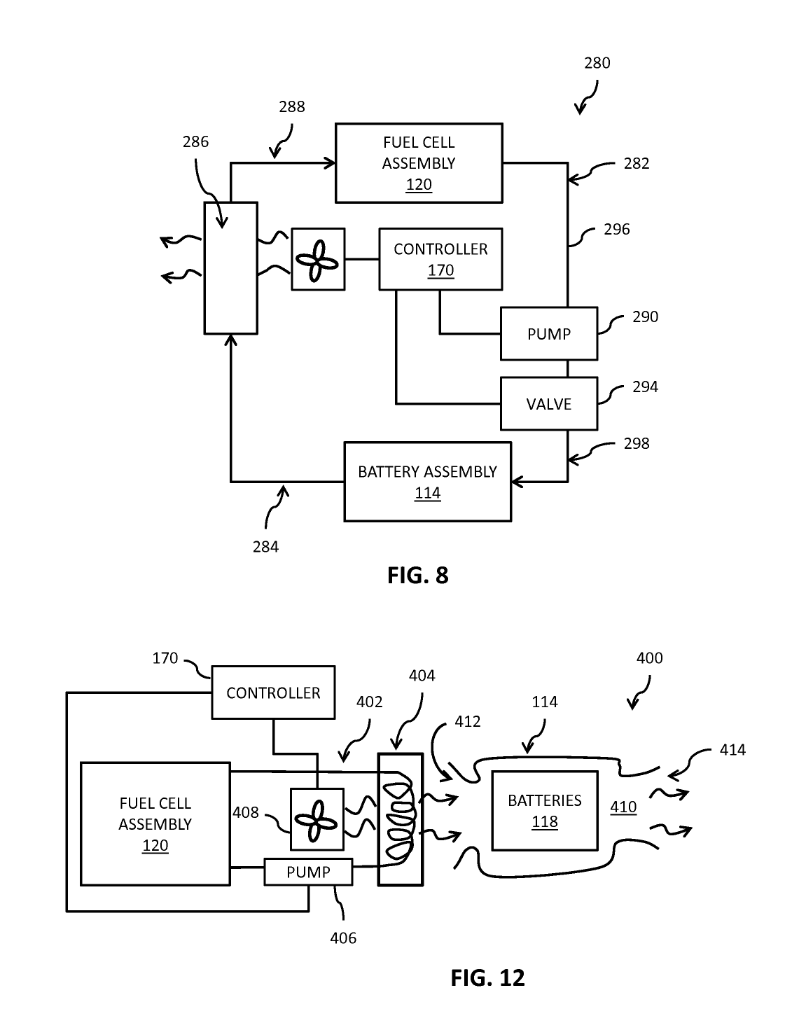

Referring to FIG. 8, another exemplary heat transfer system 280 is represented. Heat transfer system 280 is a closed loop heat transfer system containing a liquid heat transfer fluid which is pumped around heat transfer system 280 by a pump 290. The liquid heat transfer fluid takes on heat from fuel cell system 120, cooling fuel cell system 120, passes into a fluid conduit 282, and enters battery system 114. The heat transfer fluid transfers heat to the batteries 118 of battery system 114 warming batteries 118 and exits battery system 114 and passes into a fluid conduit 284. Battery system 114 includes internal fluid conduits which route the heat transfer fluid so that heat may be transferred from the heat transfer fluid to batteries 118. Exemplary fluid conduits are disclosed in US Published Patent Application No. US20080299448A1, filed Nov. 2, 2007, titled BATTERY UNIT WITH TEMPERATURE CONTROL DEVICE, the disclosure of which is expressly incorporated by reference herein in its entirety. In one embodiment, fluid conduit 284 communicates the heat transfer fluid directly back to fuel cell system 120. In the illustrated embodiment, fluid conduit 284 communicates the heat transfer fluid to a heat exchanger 286, illustratively an air cooled radiator, which removes additional heat from the heat transfer fluid to provide cooling for fuel cell system 120. A fan 292 blows air over conduits of heat exchanger 286 to cool the heat transfer fluid passing there through. The heat transfer fluid exits heat exchanger 286 and is passed to fuel cell system 120 through a fluid conduit 288.

The operation of pump 290 of heat transfer system 280 is controlled by controller 170. When controller 170 determines that heat is to be transferred from fuel cell system 120 to battery system 114, controller 170 activates pump 290 or otherwise adjusts the operation of pump 290 or other components of heat transfer system 280, such as opening a valve 294 to bring a first portion 296 of fluid conduit 282 and a second portion 298 of fluid conduit 282 into fluid communication. Further, controller 170 may adjust a speed or other parameter of pump 290 or other components of heat transfer system 280 to control a rate of heat transfer from fuel cell system 120 to battery system 114. When controller 170 determines that heat is no longer needed to be transferred from fuel cell system 120 to battery system 114 to alter the temperature associated with batteries 118, controller 170 deactivates pump 290 or otherwise adjusts the operation of pump 290 or other components of heat transfer system 280, such as closing valve 294. In one example, valve 294 connects first portion 296 of fluid conduit 282 to second portion 298 in a first configuration and to a bypass conduit connecting fluid conduit 282 and fluid conduit 284 in a second configuration. In the second configuration, heat transfer system 280 may still cool fuel cell system 120, but not heat further battery system 114. Controller 170, based on the temperature of fuel cell system 120, may activate or deactivate heat exchanger 286. When the temperature of fuel cell system 120 is above or approaching a desired operating temperature of the fuel cell system 120, heat exchanger 286 is activated to further cool the heat transfer fluid.

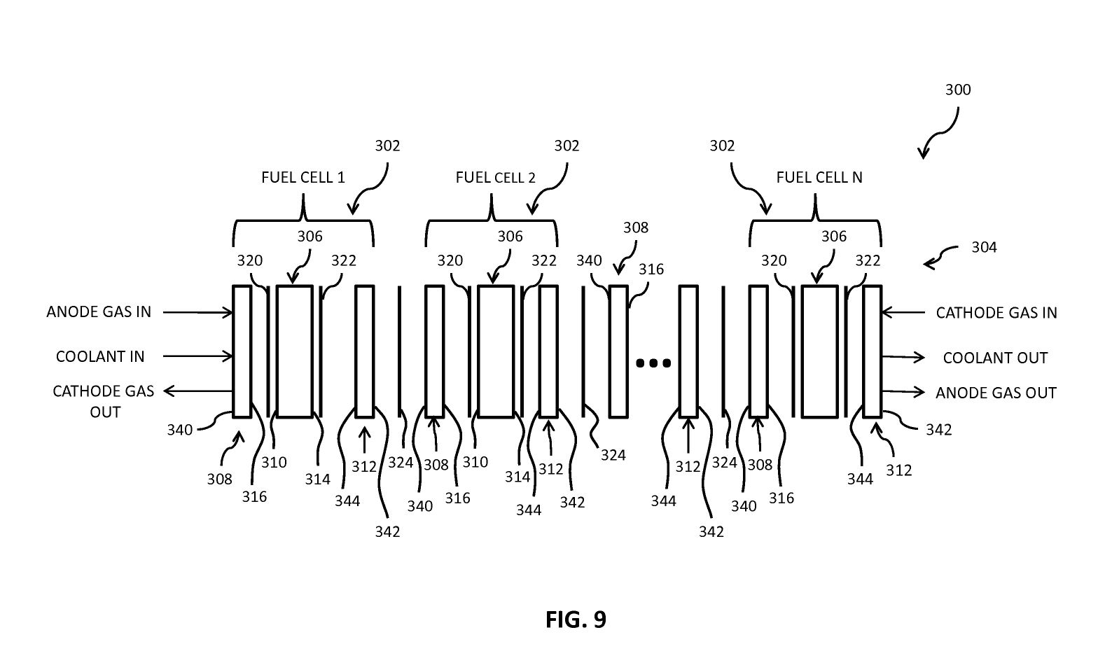

Referring to FIG. 9, an exemplary fuel cell, a high temperature PEM fuel cell 300 is illustrated. High temperature PEM fuel cell 300 includes a plurality of fuel cells 302 which form a fuel cell stack 304. Each fuel cell 302 includes a PEM unit 306 which includes an anode electrode, a cathode electrode, and a proton exchange membrane positioned therebetween. A first bipolar plate 308 is positioned on an anode side 310 of PEM unit 306 and a second bipolar plate 312 is positioned on a cathode side 314 of PEM unit 306. A seal 320 is provided between first bipolar plate 308 and PEM unit 306. A seal 322 is provided between second bipolar plate 312 and PEM unit 306. A seal 324 is provided between the second bipolar plate 312 and first bipolar plate 308 of adjacent fuel cell 302 of fuel cell stack 304. The seals 320, 322, and 324 generally seal the fluid paths flowing through fuel cell stack 304. A first fluid path is for communicating an anode gas from one of hydrogen storage tank 152 and fuel processor 154 to the anode of PEM unit 306 and exhausting anode exhaust from fuel cell 302. A second fluid path is for communicating a cathode gas from a cathode gas supply to the cathode of PEM unit 306 and exhausting cathode exhaust from fuel cell 302. A third fluid path is for communicating the heat transfer fluid of system 280 to and from high temperature PEM fuel cell 300.

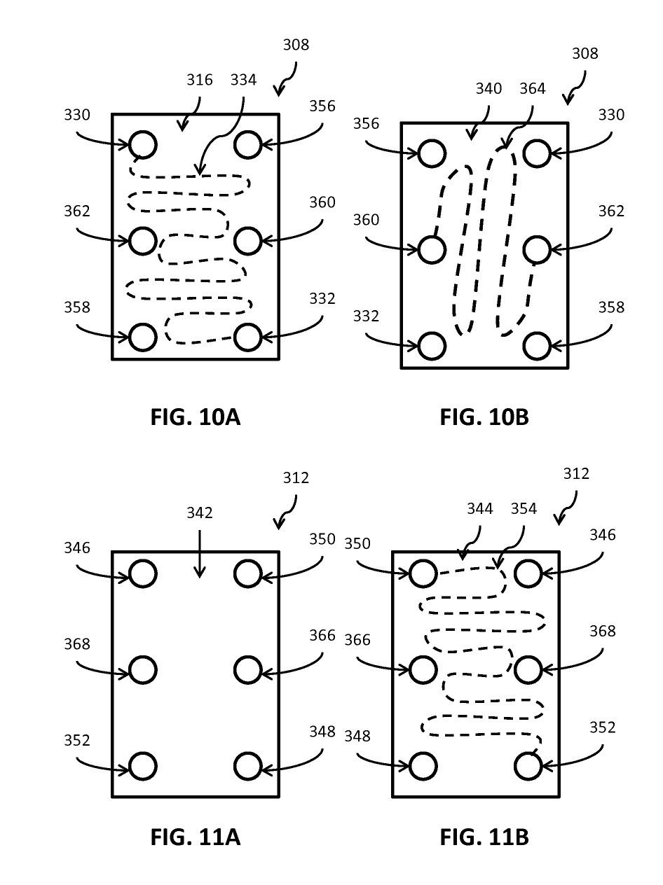

Referring to FIG. 10A, an anode facing side 316 of first bipolar plate 308 is shown. The first fluid path of high temperature PEM fuel cell 300 includes a first port 330 of first bipolar plate 308 and a second port 332 of first bipolar plate 308. Anode facing side 316 of first bipolar plate 308 includes a gas channel 334 which couples first port 330 of first bipolar plate 308 and second port 332 of first bipolar plate 308. In one example, gas channel 334 is a recess in the anode facing side 316 of first bipolar plate 308. In one example, the anode gas passes through first port 330 and gas channel 334 to bath the anode electrode in anode gas. Excess anode gas and other anode exhaust products are communicated through gas channel 334 to second port 332 and out of high temperature PEM fuel cell 300. First port 330, second port 332, and gas channel 334 are not in fluid communication with the remaining ports on first bipolar plate 308 due to seals 320 and 324. Further, the anode gas passes through a first port 346 (see FIG. 11A) of second bipolar plate 312 and the anode exhaust passes through a second port 348 (see FIG. 11A) of second bipolar plate 312. First port 346 and second port 348 are not in fluid communication with the remaining ports on second bipolar plate 312 due to seals 322 and 324.

Referring to FIG. 11B, a cathode facing side 344 of second bipolar plate 312 is shown. The second fluid path of high temperature PEM fuel cell 300 includes a third port 350 of second bipolar plate 312 and a fourth port 352 of second bipolar plate 312. Cathode facing side 344 of second bipolar plate 312 includes a gas channel 354 which couples third port 350 of second bipolar plate 312 and fourth port 352 of second bipolar plate 312. In one example, gas channel 354 is a recess in the cathode facing side 344 of second bipolar plate 312. In one example, the cathode gas passes through fourth port 352 and gas channel 354 to bath the cathode electrode in cathode gas. Excess cathode gas, water, and other cathode exhaust products are communicated through gas channel 354 to fourth port 352 and out of high temperature PEM fuel cell 300. Third port 350, fourth port 352, and gas channel 354 are not in fluid communication with the remaining ports on second bipolar plate 312 due to seals 322 and 324. Further, the cathode gas passes through a third port 356 (see FIG. 10A) of first bipolar plate 308 and the cathode exhaust passes through a fourth port 358 (see FIG. 10A) of first bipolar plate 308. Third port 356 and fourth port 358 are not in fluid communication with the remaining ports on first bipolar plate 308 due to seals 320 and 324.

Referring to FIG. 10B, a second bipolar plate facing side 340 of first bipolar plate 308 is shown. The third fluid path of high temperature PEM fuel cell 300 includes a fifth port 360 of first bipolar plate 308 and a sixth port 362 of first bipolar plate 308. Side 340 of first bipolar plate 308 includes a gas channel 364 which couples fifth port 360 of first bipolar plate 308 and sixth port 362 of first bipolar plate 308. In one example, gas channel 364 is a recess in the side 340 of first bipolar plate 308. In one example, the heat transfer fluid passes through sixth port 362 and gas channel 364 to bath side 340 of first bipolar plate 308 and a side 342 (see FIG. 11A) of second bipolar plate 312 in the heat transfer fluid, thereby transferring heat from first bipolar plate 308 and second bipolar plate 312 to the heat transfer fluid. The warmed heat transfer fluid is communicated through gas channel 364 to sixth port 362 of first bipolar plate 308 and out of high temperature PEM fuel cell 300. Fifth port 360, sixth port 362, and gas channel 364 are not in fluid communication with the remaining ports on first bipolar plate 308 due to seals 320 and 324. Further, the heat transfer fluid passes through a fifth port 366 (see FIG. 11A) of second bipolar plate 312 and a sixth port 368 (see FIG. 11A) of second bipolar plate 312. Fifth port 366 and sixth port 368 are not in fluid communication with the remaining ports on second bipolar plate 312 due to seals 322 and 324.

FIGS. 9-11 illustrate one method of removing heat from the fuel stack 150 of fuel cell system 120. Other methods may be used. An additional exemplary system for removing heat from a high temperature fuel stack 150 is disclosed in U.S. patent application Ser. No. 12/960,089, filed Dec. 3, 2010, titled HIGH TEMPERATURE PEM FUEL CELL WITH THERMAL MANAGEMENT SYSTEM, docket ND10110-21-1, the disclosure of which is incorporated herein in its entirety.

Referring to FIG. 12, another exemplary heat transfer system 400 is represented. Heat transfer system 400 includes a closed loop heat transfer circuit 402 containing a liquid heat transfer fluid which is pumped around heat transfer circuit 402 by a pump 406. The liquid heat transfer fluid takes on heat from fuel cell system 120 cooling fuel cell system 120, passes into a heat exchanger 404 wherein it is cooled, and recirculated back to fuel cell system 120. In the illustrated embodiment, heat exchanger 404 is an air cooled radiator which removes heat from the heat transfer fluid. A fan 408 blows air over conduits of heat exchanger 404 to cool the heat transfer fluid passing there through. The heat transfer fluid exits heat exchanger 404 and is recirculated back to fuel cell system 120. The heat of the heat transfer fluid in circuit 402 is transferred to a second heat transfer fluid, the blown air, in heat exchanger 404. The heated air is directed through an inlet duct 412 of battery system 114 into an interior 410 of battery system 114 where it heats batteries 118. The air is then exhausted out of battery system 114 through an exhaust duct 414. In one embodiment, battery system 114 includes internal fluid conduits which route the heat transfer fluid to transfer heat from the heat transfer fluid to batteries 118. Exemplary fluid conduits are disclosed in US Published Patent Application No. US20080299448A1, filed Nov. 2, 2007, titled BATTERY UNIT WITH TEMPERATURE CONTROL DEVICE, the disclosure of which is expressly incorporated by reference herein in its entirety.

The operation of heat transfer system 400 is controlled by controller 170. When controller 170 determines that heat is to be transferred from fuel cell system 120 to battery system 114, controller 170 activates fan 408 or otherwise adjusts the operation of fan 408 or other components of heat transfer system 400, such as fluidly coupling inlet duct 412 of battery system 114 with heat exchanger 404. Further, controller 170 may adjust a speed or other parameter of fan 408 or other components of heat transfer system 400 to control a rate of heat transfer from fuel cell system 120 to battery system 114. When controller 170 determines that heat is no longer needed to be transferred from fuel cell system 120 to battery system 114 to alter the temperature associated with batteries 118, controller 170 deactivates fan 408 or otherwise adjusts the operation of fan 408 or other components of heat transfer system 400, such as redirecting the heated air to an exhaust duct independent of battery system 114.

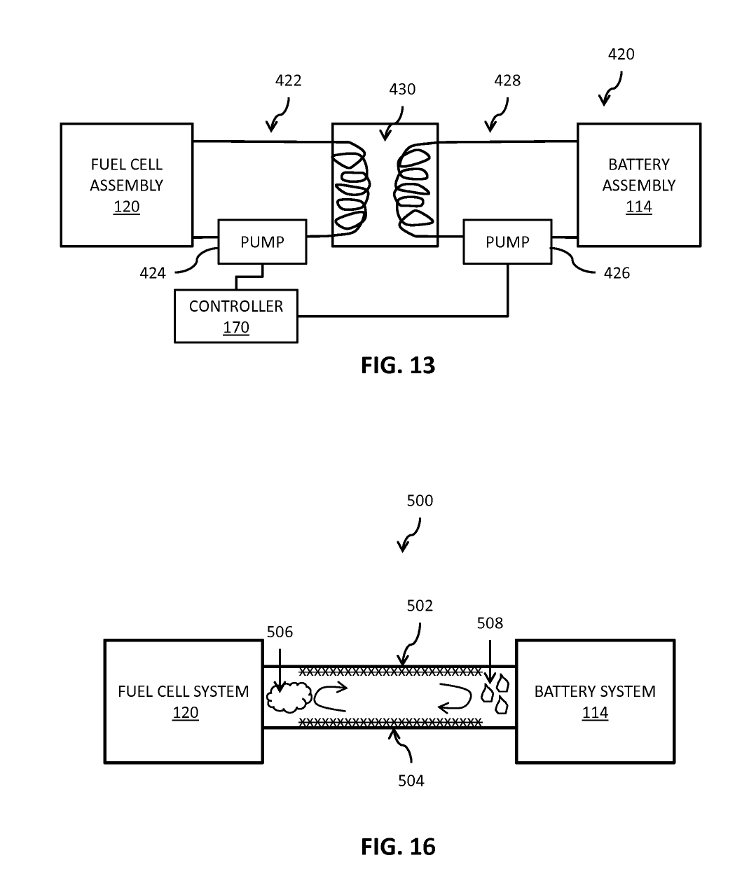

Referring to FIG. 13, another exemplary heat transfer system 420 is represented. Heat transfer system 420 includes a first closed loop heat transfer circuit 422 containing a liquid heat transfer fluid which is pumped around heat transfer circuit 422 by a pump 424 and a second closed loop heat transfer circuit 428 containing a liquid heat transfer fluid which is pumped around heat transfer circuit 428 by a pump 426. Both of first heat transfer circuit 422 and second heat transfer circuit 428 interact with a heat exchanger 430. An exemplary heat exchanger 430 is a shell and tube heat exchanger.

In operation, the liquid heat transfer fluid in heat transfer circuit 422 takes on heat from fuel cell system 120 cooling fuel cell system 120, passes into heat exchanger 430 wherein it is cooled, and recirculates back to fuel cell system 120. The liquid heat transfer fluid in heat transfer circuit 428 enters heat exchanger 430 wherein it is heated, passes into battery system 114 wherein it provides heat to warm batteries 118, and is recirculated back to heat exchanger 430 to take on additional heat. In one embodiment, battery system 114 includes internal fluid conduits which route the heat transfer fluid to transfer heat from the heat transfer fluid to batteries 118. Exemplary fluid conduits are disclosed in US Published Patent Application No. US20080299448A1, filed Nov. 2, 2007, titled BATTERY UNIT WITH TEMPERATURE CONTROL DEVICE, the disclosure of which is expressly incorporated by reference herein in its entirety.

The operation of heat transfer system 420 is controlled by controller 170. When controller 170 determines that heat is to be transferred from fuel cell system 120 to battery system 114, controller 170 activates pump 424 of heat transfer circuit 422 and pump 426 of heat transfer circuit 428 or otherwise adjusts the operation of one or both of pump 424 and pump 426 or other components of one or both of heat transfer circuit 422 and heat transfer circuit 428. Further, controller 170 may adjust a speed or other parameter of one or both of pump 424 and pump 426 or other components of one or both of heat transfer circuit 422 and heat transfer circuit 428 to control a rate of heat transfer from fuel cell system 120 to battery system 114. When controller 170 determines that heat is no longer needed to be transferred from fuel cell system 120 to battery system 114 to alter the temperature associated with batteries 118, controller 170 deactivates one or both of pump 424 and pump 426 or otherwise adjusts the operation of one or both of pump 424 and pump 426 or other components of one or both of heat transfer circuit 422 and heat transfer circuit 428.

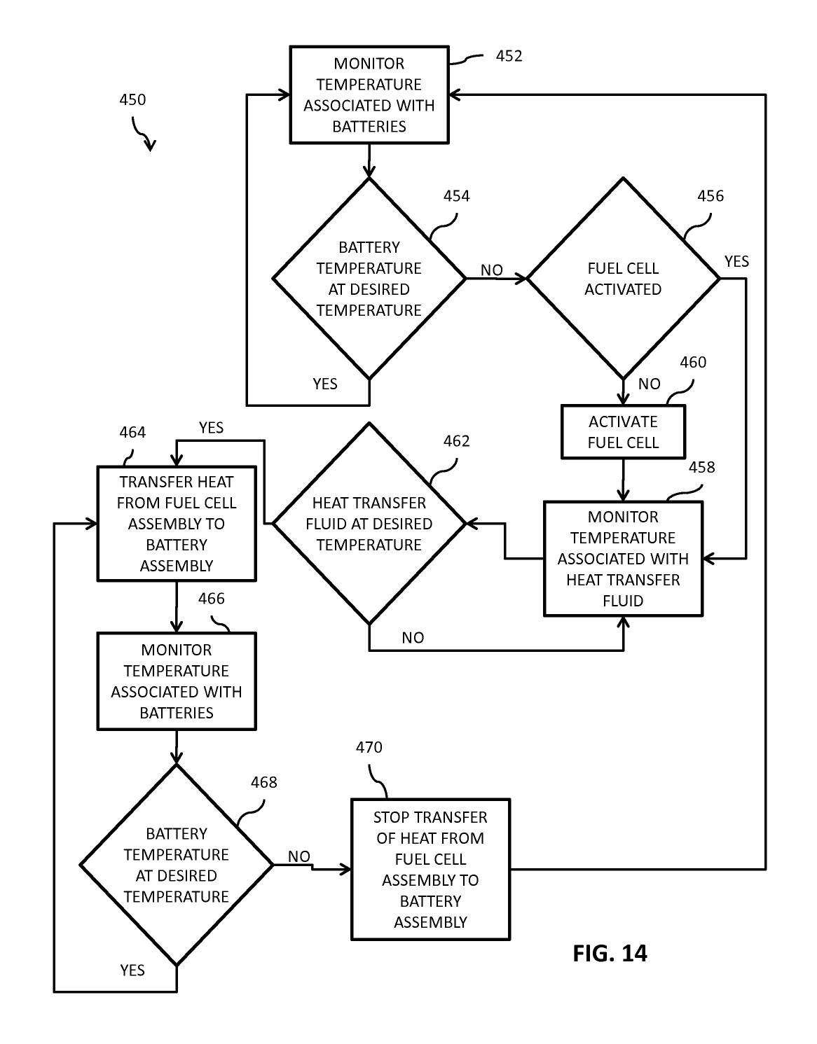

Referring to FIG. 14, an exemplary processing sequence 450 of controller 170 is illustrated. The operation of processing sequence 450 is discussed in relation to the operation of heat transfer system 280, heat transfer system 400, and heat transfer system 420 but is applicable to other heat transfer systems. Controller 170 monitors the temperature associated with batteries 118, as represented by block 452. In one embodiment, controller 170 monitors the temperature of temperature sensor 122. Controller 170 determines if the current battery temperature is at a desired temperature, as represented by block 454. In one embodiment, the current battery temperature is at the desired temperature when it is above a threshold temperature. In one example, batteries 118 are lithium ion batteries and exemplary threshold temperatures include about 25° C., about 30° C., about 40° C., and about 50° C. In one example, batteries 118 are molten salt batteries and exemplary threshold temperatures include about 250° C., about 300° C., and about 400° C. In one example, batteries 118 are lead acid batteries and exemplary threshold temperatures include about 10° C. and about 20° C. In one example, batteries 118 are NiMH batteries and exemplary threshold temperatures include about 20° C. and about 40° C. In one embodiment, the current battery temperature is at the desired temperature when it is within a first temperature range. In one example, batteries 118 are lithium ion batteries and exemplary first temperature ranges include from about 25° C. to about 50° C., from about 30° C. to about 40° C., and from about 30° C. to about 50° C. In one example, batteries 118 are molten salt batteries and exemplary first temperature ranges include from about 250° C. to about 400° C., from about 250° C. to about 700° C., and from about 300° C. to about 400° C. In one example, batteries 118 are lead acid batteries and an exemplary first temperature range is from about 10° C. to about 20° C. In one example, batteries 118 are NiMH batteries and an exemplary first temperature range is from about 20° C. to about 40° C.

If the current battery temperature is lower than the desired temperature, controller 170 determines if fuel cell system 120 is activated, as represented by block 456. If fuel cell system 120 is activated, controller 170 monitors the temperature of the heat transfer fluid which is in fluid communication with fuel cell system 120, as represented by block 458. In one example, controller 170 monitors a temperature sensor associated with the heat transfer fluid. In one example, controller 170 monitors a temperature of fuel cell system 120 with temperature sensor 132 and uses that temperature as the temperature of the heat transfer fluid. If the fuel cell system 120 is not activated, controller 170 first activates fuel cell system 120, as represented by block 460, and then proceeds to monitoring the temperature of the heat transfer fluid, as represented by block 458.

Controller 170 determines if the heat transfer fluid is at a desired temperature for heat transfer to batteries 118, as represented by block 462. In one embodiment, the desired temperature of the heat transfer fluid is at least as warm as the desired temperature of batteries 118. Once the heat transfer fluid reaches the desired temperature for heat transfer to batteries 118, controller 170 causes heat to be transferred from fuel cell system 120 to battery system 114 to raise the temperature associated with batteries 118 of battery system 114, as represented by block 464. In the case of the illustrated embodiment of heat transfer system 280, controller 170 activates pump 290 and configures valve 294 to bring first portion 296 of fluid conduit 282 and second portion 298 of fluid conduit 282 into fluid communication. In the case of the illustrated embodiment of heat transfer system 400, controller 170 activates pump 406 and fan 408. In the case of the illustrated embodiment of heat transfer system 420, controller activates pump 424 and pump 426.

The temperature of the heat transfer fluid may continue to rise as the fuel cell system 120 continues to produce heat, thereby increasing the potential heat transfer rate to the batteries 118. As such, in general the higher the operating temperature of the fuel cell, the shorter the warm-up time for batteries 118.

Controller 170 continues to monitor the temperature associated with batteries 118 of battery system 114 during heating, as represented by block 466. Controller 170 determines if the temperature associated with batteries 118 of battery system 114 is at the desired temperature, as represented by block 468. When the current battery temperature is at the desired temperature, controller 170 stops the transfer of heat from fuel cell system 120 to battery system 114, as represented by block 470. In the case of the illustrated embodiment of heat transfer system 280, controller 170 deactivates pump 290 and configures valve 294 so first portion 296 of fluid conduit 282 and second portion 298 of fluid conduit 282 are no longer in fluid communication. In one example, controller 170 keeps pump 290 activated and uses a bypass fluid conduit to continue to cool fuel cell system 120. In the case of the illustrated embodiment of heat transfer system 400, controller 170 deactivates pump 406 and fan 408. In one example, controller 170 keeps pump 406 and fan 408 activated and heat transfer system 400 includes a diverter or other device to direct the heated air to an exhaust. In the case of the illustrated embodiment of heat transfer system 420, controller deactivates pump 424 and pump 426. In one example, controller keeps pumps 424 and 426 activated, but through valves or other methods removes the battery system from the circuit 428 and couples in a bypass conduit including a heat exchanger which may provide cooling to the heat exchange fluid.

In one embodiment, controller 170 deactivates fuel cell system 120. In one embodiment, controller 170 controls a heat transfer system to stop the transfer of heat from an activated fuel cell system 120 to battery system 114. In this embodiment, fuel cell system 120 remains active and may provide power to trickle charge batteries 118 of battery system 114, to provide power to vehicle propulsion bus 116, or to power one or more auxiliary devices of vehicle 100.

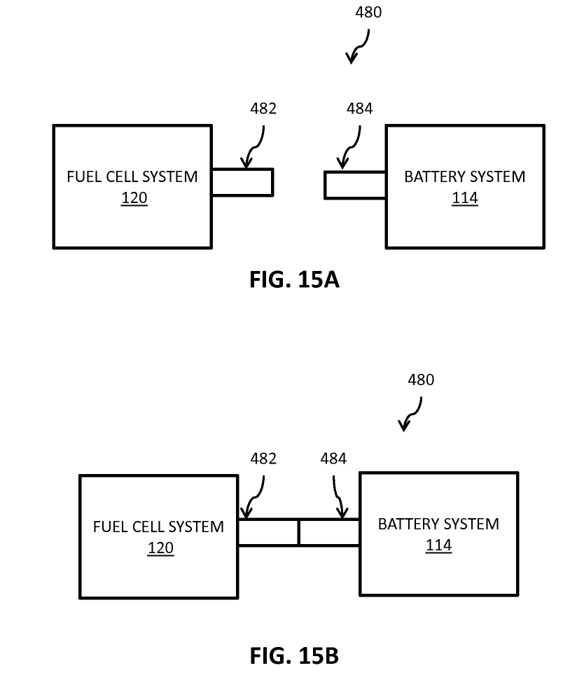

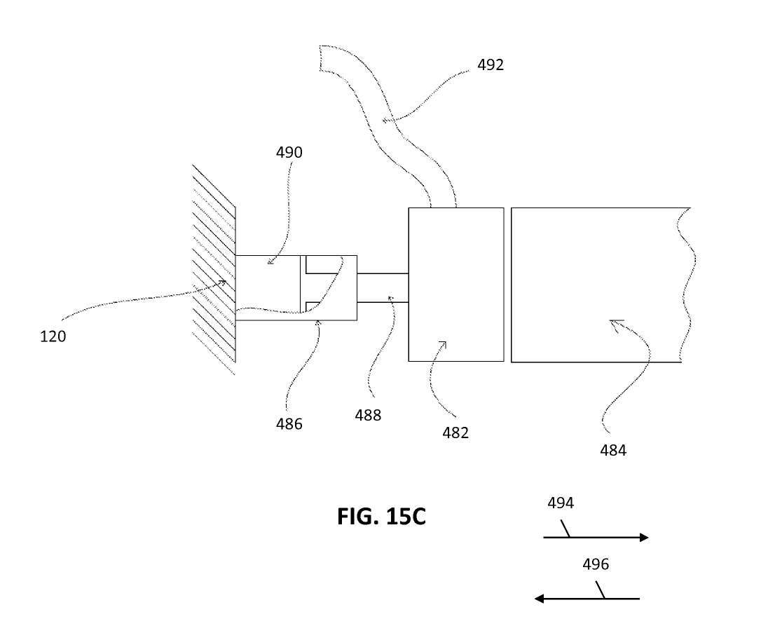

Referring to FIGS. 15A and 15B, a further exemplary heat transfer system 480 is illustrated. Heat transfer system 480 transfers heat from fuel cell system 120 to battery system 114 through direct conduction. Fuel cell system 120 has a first thermal sink 482 coupled thereto to receive heat from the operation of fuel cell system 120. Battery system 114 has a second thermal sink 484 coupled thereto to provide heat to batteries 118 of battery system 114. First thermal sink 482 and second thermal sink 484 are made of materials having good thermal conductivity properties. When first thermal sink 482 and second thermal sink 484 are spaced apart, as shown in FIG. 15A, heat is not conducted from first thermal sink 482 to second thermal sink 484 by direct conduction. When first thermal sink 482 and second thermal sink 484 are in contact, as shown in FIG. 15B, heat may flow from the hotter first thermal sink 482 to the cooler second thermal sink 484. In this way, heat is transferred from fuel cell system 120 to battery system 114 to warm batteries 118.

In one embodiment, controller 170 controls the relative positions of first thermal sink 482 and second thermal sink 484. Referring to FIG. 15C, in one embodiment an actuator 486 is coupled to a base, illustratively fuel cell system 120. The actuator includes a piston 488 and a chamber 490 positioned behind the piston 488. Thermal sink 482 is supported by piston 488 and moveable with piston 488. Thermal sink is thermally coupled to fuel cell system 120 though a flexible cable 492 which communicates heat from fuel cell system 120 to first thermal sink 482. By advancing piston 488 in direction 494 first thermal sink 482 and second thermal sink 484 may be brought into contact. The advancement of piston 488 in direction 494 may be the result of a hydraulic system which increases a hydraulic pressure in chamber 490, a pneumatic system which increases a pneumatic pressure in chamber 490, the expansion of a thermal expansion material provided in chamber 490, or by other suitable actuation devices. By retracting piston 488 in direction 496 first thermal sink 482 may be separated from second thermal sink 484. The retraction of piston 488 in direction 496 may be the result of a biasing member positioned between the piston head and the end wall of actuator 486 or in other suitable actuation devices. As such, actuator 486 may be hydraulically operated, pneumatically operated, operated based on the property of a thermal expansion material, or use other suitable actuation methods.

The rate of heat transfer from first thermal sink 482 to second thermal sink 484 is based on a resistivity of the thermal circuit established by first thermal sink 482 and second thermal sink 484. By altering the resistivity of the thermal circuit, controller 170 is able to control a rate of heat transfer from fuel cell system 120 to battery system 114. The resistivity of the thermal circuit may be altered by changing a length of the combined first thermal sink 482 and second thermal sink 484 or changing the contact area between first thermal sink 482 and second thermal sink 484. For instance, by splitting first thermal sink 482 into components multiple actuators each supporting a portion of first thermal sink 482 may be individually actuated to vary a contact area between first thermal sink 482 and second thermal sink 484.

Referring to FIG. 16, another exemplary heat transfer system 500 is illustrated. Heat transfer system 500 is a passive heat transfer system. Heat transfer system 500 includes a housing 502 which is thermally coupled to fuel cell system 120 and battery system 114. Housing 502 contains therein a working fluid and wicking material 504. The chemical properties of the working fluid and the pressure within the housing 502 are selected so that when the working fluid is at or above a first temperature it is in a gaseous state and when it is below the first temperature it is in a liquid state. In the case of heat transfer system 500, the working fluid is selected to have a first temperature which generally corresponds to a desired temperature of batteries 118. In one embodiment, the batteries 118 are lithium ion batteries and exemplary desired temperatures include about 25° C., about 30° C., about 40° C., and about 50° C. In one embodiment, the batteries 118 are molten salt batteries and exemplary desired temperatures include about 250° C., about 300° C., and about 400° C. In one embodiment, batteries 118 are lead acid batteries and exemplary desired temperatures include about 10° C. and about 20° C. In one embodiment, batteries 118 are NiMH batteries and exemplary desired temperatures include about 20° C. and about 40° C.

When fuel cell system 120 is at its operating temperature, it is at a temperature above the first temperature. In one example, the first temperature is about 40° C. and the operating temperature of fuel cell system 120 is in the range of about 120° C. to about 150° C. An interior first region 506 of housing 502 is thermally coupled to fuel cell system 120. As such, the working fluid in region 506 generally takes on heat and evaporates. The gaseous working fluid travels through heat transfer system 500 towards a second region 508 which is thermally coupled to batteries 118 of battery system 114. When batteries 118 are in need of being warmed, second region 508 is generally below the first temperature of the working fluid. This results in the working fluid condensing in region 508 and thereby giving up heat to batteries 118 of battery system 114. The liquid working fluid is transported back towards region 506 through wicking material 504. This cycle continues as long as batteries 118 of battery system 114 are at or below the first temperature of the working fluid.

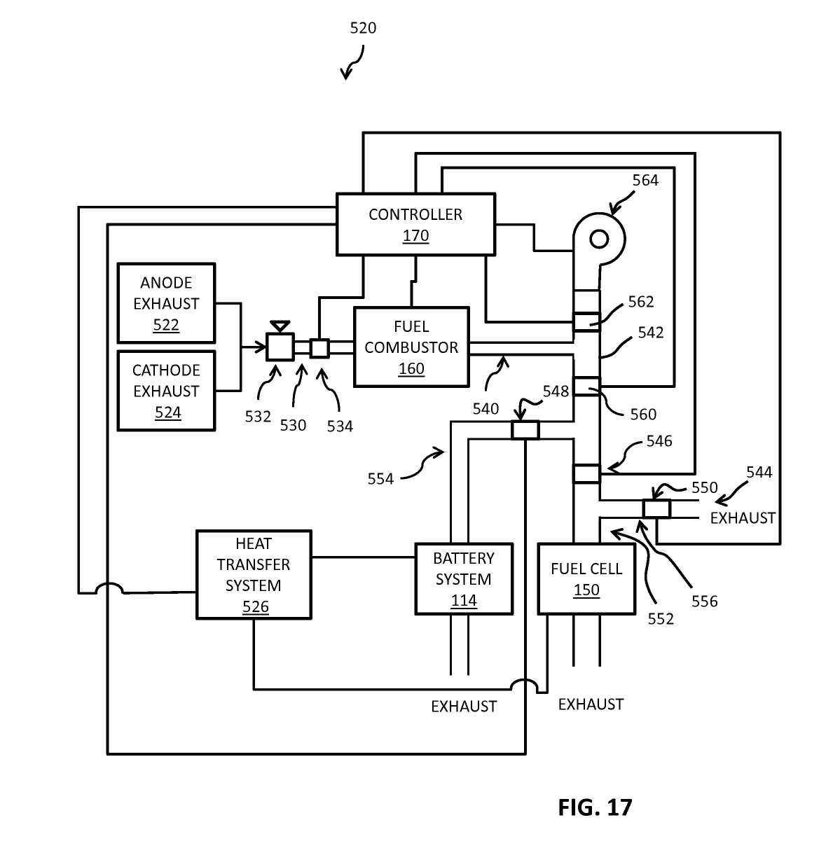

Referring to FIG. 17, an exemplary heat transfer system 520 is illustrated. System 520 uses two different outputs of fuel cell system 120 to warm batteries 118. Heat transfer system 520 uses an effluent and a transfer of heat from fuel cell system 120 to battery system 114 with a heat transfer system 526. Heat transfer system 526 may be one of the exemplary heat transfer systems disclosed herein.

Heat transfer system 520 uses hot effluent from fuel combustor 160 to warm one or both of high temperature fuel cell stack 150 and batteries 118 of battery system 114. In general, high temperature fuel cell stack 150 is provided with greater than the stoichiometric flow rate of anode fuel and cathode fuel or oxidant to assure general uniformity of the reaction over the active areas of the anode and cathode and to assist in purging non-reactive materials. Fuel combustor 160 is used to process the excess anode fuel and cathode oxidant. The heat of combustion which is expelled from fuel combustor 160 as part of the effluent may be used to warm one or both of batteries 118 and high temperature fuel cell stack 150.

As illustrated in FIG. 17, the anode exhaust 522 of high temperature fuel cell stack 150 and the cathode exhaust 524 of high temperature fuel cell stack 150 are provided to a fluid conduit 530 through a metering valve 532. Fluid conduit 530 is in fluid communication with fuel combustor 160 through a valve 534 which is controlled by controller 170. In a first configuration, fluid conduit 530 allows the fuel cell exhaust in fluid conduit 530 to pass into fuel combustor 160. In a second configuration, fluid conduit 530 prevents the fuel cell exhaust in fluid conduit 530 from entering into fuel combustor 160. Fuel combustor 160 is controlled by controller 170 and when activated burns the combustible material present in the exhaust and expels effluent into a fluid conduit 540.

Fluid conduit 540 is in fluid communication with a fluid conduit 542. The effluent may flow through fluid conduit 542 to one or more of battery system 114, high temperature fuel cell stack 150, and an exhaust port 544 based on the respective configuration of respective valves 546, 548, and 550. Valve 546 has a first configuration which permits the effluent to flow through fluid conduit 552 to reach and interact with high temperature fuel cell stack 150 to warm high temperature fuel cell stack 150 and a second configuration which blocks the effluent from reaching high temperature fuel cell stack 150. Valve 548 has a first configuration which permits the effluent to flow through fluid conduit 554 to reach and interact with battery system 114 to warm batteries 118 and a second configuration which blocks the effluent from reaching battery system 114. Valve 550 has a first configuration which permits the effluent to flow through fluid conduit 556 to reach and exit exhaust port 544 and a second configuration which blocks the effluent from reaching exhaust port 544. The operation of valve 546, valve 548, and valve 550 are controlled by controller 170. The effluent, if passed to either battery system 114 or high temperature fuel cell stack 150, is eventually exhausted from battery system 114 or high temperature fuel cell stack 150.

Controller 170 monitors a temperature of the fluid within fluid conduit 542 with a temperature sensor 560. Depending on the temperature, controller 170 may activate a blower 564 which provides a cooler flow of air that dilutes the effluent and diffuses combustible products within the effluent. A valve 562 is provided between blower 564 and fluid conduit 542. By adjusting the position of valve 562, controller 170 is able to adjust the amount of air being supplied by blower 564 to fluid conduit 542. In one embodiment, the amount of air being supplied by blower 564 to fluid conduit 542 is controlled by controller 170 by controlling the altering a speed of blower 564.

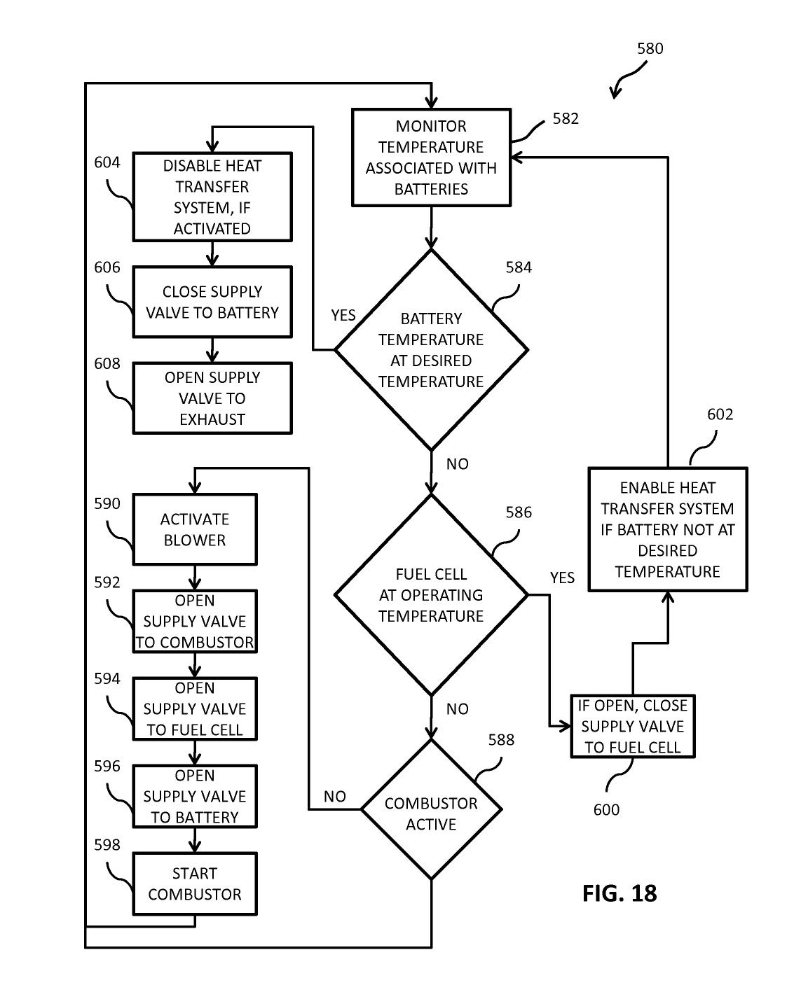

Referring to FIG. 18, an exemplary processing sequence 580 of controller 170 for the operation of heat transfer system 520 is illustrated. Controller 170 monitors the temperature associated with batteries 118, as represented by block 582. In one embodiment, controller 170 monitors the temperature of temperature sensor 122. Controller 170 determines if the current battery temperature is at a desired temperature, as represented by block 584. In one embodiment, the current battery temperature is at the desired temperature when it is above a threshold temperature. In one example, batteries 118 are lithium ion batteries and exemplary threshold temperatures include about 25° C., about 30° C., about 40° C., and about 50° C. In one example, batteries 118 are molten salt batteries and exemplary threshold temperatures include about 250° C., about 300° C., and about 400° C. In one example, batteries 118 are lead acid batteries and exemplary threshold temperatures include about 10° C. and about 20° C. In one example, batteries 118 are NiMH batteries and exemplary threshold temperatures include about 20° C. and about 40° C. In one embodiment, the current battery temperature is at the desired temperature when it is within a first temperature range. In one example, batteries 118 are lithium ion batteries and exemplary first temperature ranges include from about 25° C. to about 50° C., from about 30° C. to about 40° C., and from about 30° C. to about 50° C. In one example, batteries 118 are molten salt batteries and exemplary first temperature ranges include from about 250° C. to about 400° C., from about 250° C. to about 700° C., and from about 300° C. to about 400° C. In one example, batteries 118 are lead acid batteries and an exemplary first temperature range is from about 10° C. to about 20° C. In one example, batteries 118 are NiMH batteries and an exemplary first temperature range is from about 20° C. to about 40° C.

If the current battery temperature is lower than the desired temperature, controller 170 determines if fuel cell system is operating at its operating temperature, as represented by block 586. If the current fuel cell temperature is lower than its operating temperature, then controller 170 determines if the fuel combustor 160 is active, as represented by block 588. If fuel combustor 160 is active, control is returned to block 582 to update the battery temperature reading because heat transfer system 520 is already actively warming batteries 118.

If fuel combustor 160 is not activated, controller 170 activates the blower 564, as represented by block 590. Controller 170 further opens valve 534, valve 546, and valve 548, as represented by blocks 592, 594, and 596, respectively. Controller 170 activates fuel combustor 160, as represented by block 598 and control is returned to block 582.

Once fuel cell 150 reaches its operating temperature, valve 546 is closed by controller 170, as represented by block 600. If batteries 118 have not reached their desired temperature yet, controller 170 enables a heat transfer system to remove heat from the high temperature fuel cell stack 150 and provide the heat to batteries 118, as represented by block 602. Now batteries 118 are being warmed by both the effluent of fuel combustor 160 and the enabled heat transfer system providing heat from high temperature fuel cell stack 150.

Once batteries 118 reach their desired temperature, the enabled heat transfer system, if any, is disabled by controller 170, as represented by block 604. Further, controller 170 closes valve 548 and opens valve 550, as represented by blocks 606 and 608, respectively.

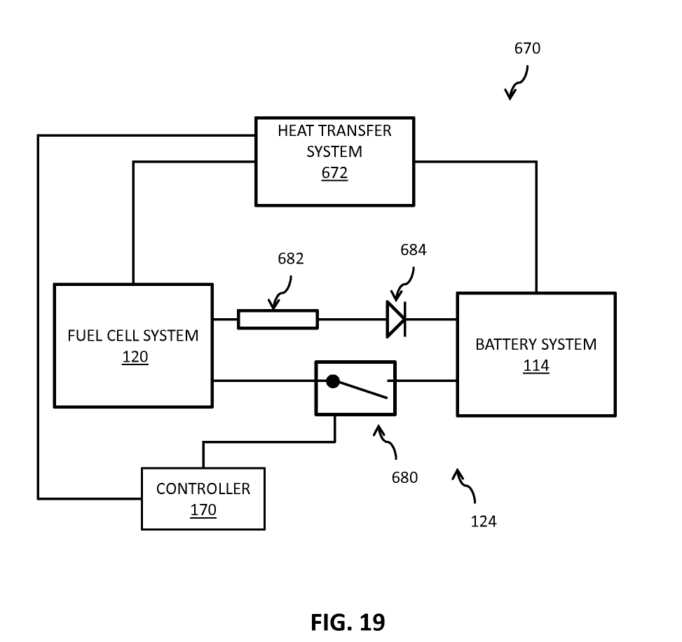

Referring to FIG. 19, an exemplary system 670 is illustrated. System 670 uses two different outputs of fuel cell system 120 to warm batteries 118. Unlike heat transfer system 520 which used an effluent and a transfer of heat from fuel cell system 120 to battery system 114 with a heat transfer system, heat transfer system 670 uses a direct electrical connection 124 between battery system 114 and fuel cell system 120 and a transfer of heat from fuel cell system 120 to battery system 114 with a heat transfer system 672. Heat transfer system 672 may be one of the exemplary heat transfer systems disclosed herein.

In FIG. 19, fuel cell system 120 is connected to battery system 114 through electrical connection 124 which generally ties the voltage of high temperature fuel cell stack 150 to be equal to the voltage of batteries 118. When batteries 118 are discharged or at low temperature, batteries 118 have a low voltage and may absorb higher current levels from high temperature fuel cell stack 150. High temperature fuel cell stack 150 is less efficient at low voltage levels and due to the lower efficiency more heat is produced by high temperature fuel cell stack 150. This heat is transferred to the heat transfer fluid of heat transfer system 672 which provides it to batteries 118. As batteries 118 warm up, the voltage of batteries 118 rises. This in turn raises the voltage of high temperature fuel cell stack 150 which increases the efficiency of high temperature fuel cell stack 150. The increased efficiency results is less heat being produced by high temperature fuel cell stack 150 and transferred by heat transfer system 672. System 670 provides additional heat to batteries 118 when the temperature of batteries 118 is low and scales back the amount of heat as the temperature of batteries 118 rises. As the temperature of batteries 118 continues to rise, electrical connection 124 may be opened to electrically uncouple batteries 118 and high temperature fuel cell stack 150.

In one embodiment, heat transfer system 672 removes heat from fuel processor 154 to provide to batteries 118. The startup process of a fuel cell system 120 that includes a reformer 154 produces a higher level of heat from the oxidation of fuel during the initial reformation reaction compared to normal operation. This high rate heat production during startup is well matched with the periods in which the batteries 118 most likely requires heat up (i.e., during vehicle start). During vehicle start, the fuel cell 120 can provide heat to the batteries 118 to warm them while supplementing the electric power requirements for vehicle propulsion.

Electrical connection 124 includes a contactor 680 which is controlled by controller 170. When contactor 680 is in a first configuration, electrical connection 124 is open and when contactor 680 is in a second configuration electrical connection 124 is closed. Electrical connection 124 further includes a current limiter device 682 to limit the amount of current that may be drawn by batteries 118 and a diode 684 which ensures that current flows in one direction.

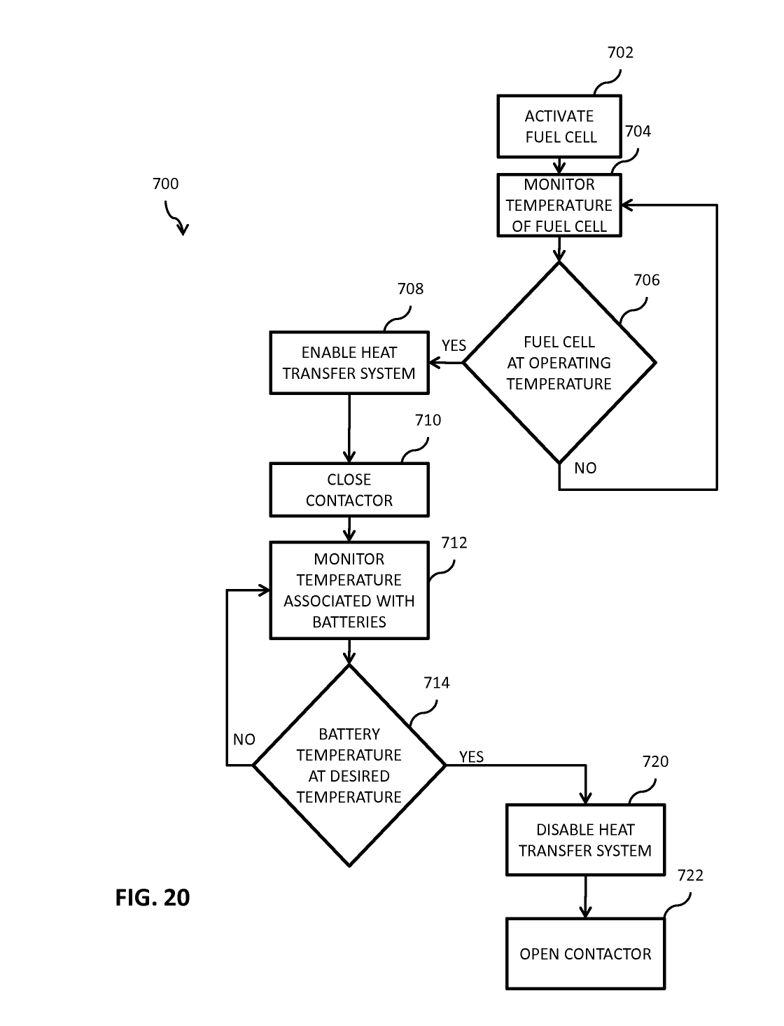

Referring to FIG. 20, an exemplary processing sequence 700 of controller 170 for the operation of heat transfer system 670 is illustrated. When batteries 118 are to be warmed, controller 170 activates fuel cell system 120, as represented by block 702. Controller monitors the temperature of fuel cell system 120, as represented by block 704. When controller 170 determines that fuel cell system 120 is at its operating temperature, controller 170 enables heat transfer system 672, as represented by blocks 706 and 708. Controller 170 further closes contactor 680 which closes electrical connection 124, as represented by block 710.

Controller monitors the temperature associated with batteries 118 to determine if batteries 118 are at a desired temperature, as represented by blocks 712 and 714. In one embodiment, the current battery temperature is at the desired temperature when it is above a threshold temperature. In one example, batteries 118 are lithium ion batteries and exemplary threshold temperatures include about 25° C., about 30° C., about 40° C., and about 50° C. In one example, batteries 118 are molten salt batteries and exemplary threshold temperatures include about 250° C., about 300° C., and about 400° C. In one example, batteries 118 are lead acid batteries and exemplary threshold temperatures include about 10° C. and about 20° C. In one example, batteries 118 are NiMH batteries and exemplary threshold temperatures include about 20° C. and about 40° C. In one embodiment, the current battery temperature is at the desired temperature when it is within a first temperature range. In one example, batteries 118 are lithium ion batteries and exemplary first temperature ranges include from about 25° C. to about 50° C., from about 30° C. to about 40° C., and from about 30° C. to about 50° C. In one example, batteries 118 are molten salt batteries and exemplary first temperature ranges include from about 250° C. to about 400° C., from about 250° C. to about 700° C., and from about 300° C. to about 400° C. In one example, batteries 118 are lead acid batteries and an exemplary first temperature range is from about 10° C. to about 20° C. In one example, batteries 118 are NiMH batteries and an exemplary first temperature range is from about 20° C. to about 40° C.

Once batteries 118 reach their desired temperature, the enabled heat transfer system, if any, is disabled by controller 170, as represented by block 720. Further, controller 170 opens contactor 680, as represented by block 722. In one embodiment, heat transfer system 672 uses the effluent from fuel combustor 160 to warm batteries 118 like heat transfer system 520. In this embodiment, when batteries 118 are at the operating temperature controller 170 also opens valve 550 and closes valves 546 and 548, if opened.

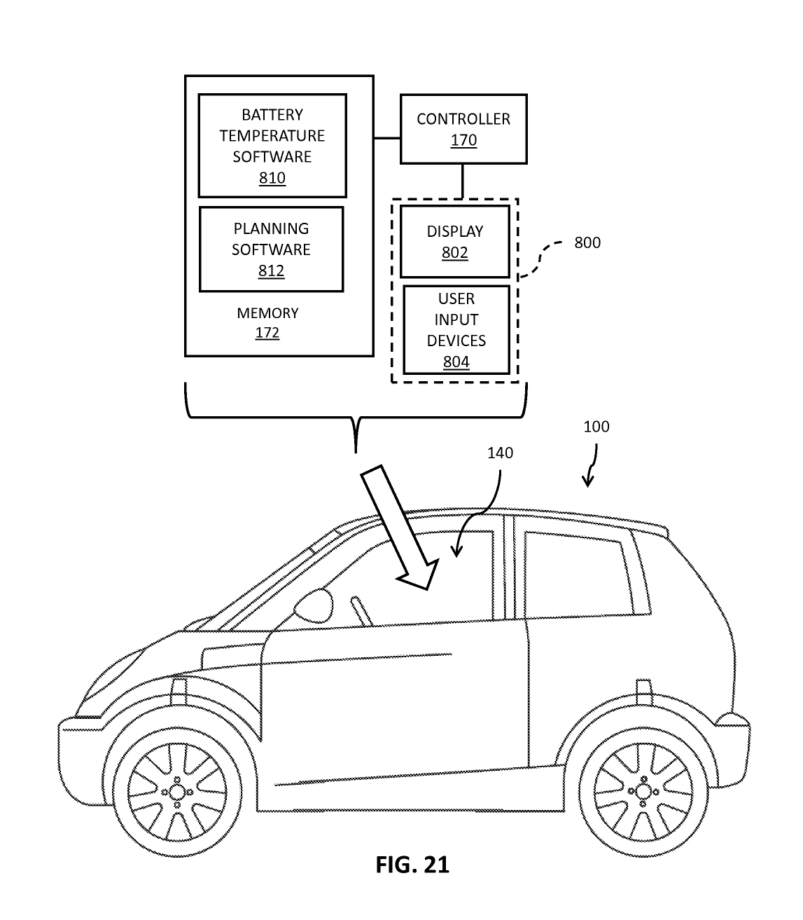

Referring to FIG. 21, controller 170 is operatively coupled to an operator interface 800 which is accessible from the passenger compartment 140 of vehicle 100. Operator interface 800 may be part of a console of vehicle 100. In the illustrated embodiment, operator interface 800 includes an exemplary output device, a display 802, and one or more input devices 804. Through display 802, controller 170 is able to provide information to an operator of vehicle 100. With input devices 804, controller 170 is able to receive inputs from the operator of vehicle 100. Exemplary input devices 804 include buttons, knobs, keys, switches, a mouse, a touch screen, a roller ball, a microphone, and other suitable devices for providing an input to controller 170. Further exemplary output devices include a speaker and other suitable devices for providing information to the operator.

Memory 172 includes battery temperature software 810 which warms the batteries 118 of battery system 114. In one embodiment, battery temperature software 810 warms the batteries 118 in accordance with one or more of the processing sequences disclosed herein. Memory 172 further includes planning software 812. Planning software 812 determines the timeframe to warm the batteries 118 of vehicle 100, if necessary, based on a received indication of a future trip of vehicle 100 or other future use for batteries 118 either in a vehicle or associated with another device.

In one embodiment, planning software 812 receives an indication of a future trip through operator interface 800. In this embodiment, an operator of vehicle 100 would interact with operator interface 800 to provide a time that vehicle 100 should be ready for departure. Planning software 812 based on the received time may warm the batteries for the future departure. In one example, the operator of vehicle 100 provides both a time that vehicle 100 should be ready for departure and an expected range for vehicle 100. In this manner, planning software 812 may both warm the batteries 118 for the future trip and charge the batteries 118 for the expected range.

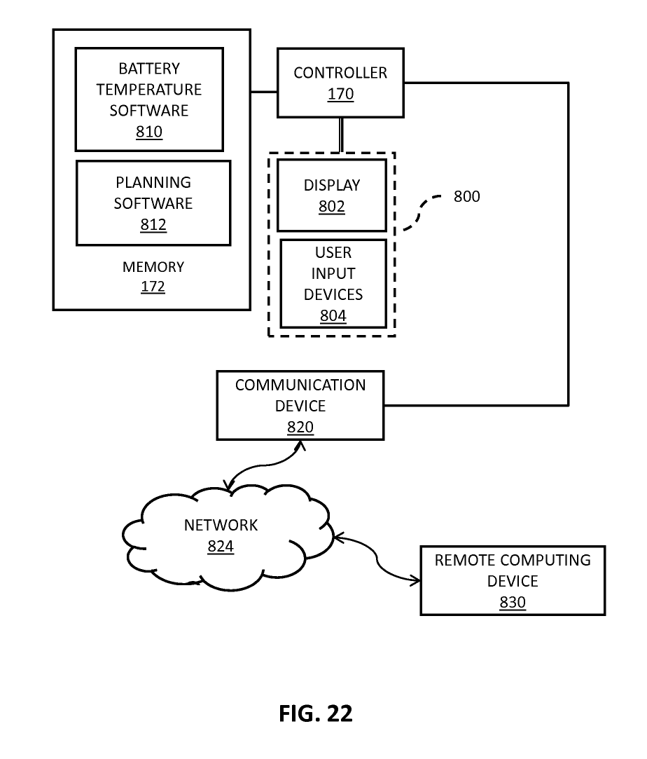

Referring to FIG. 22, controller 170 is operatively coupled to a communication device 820. Communication device 820 operatively couples controller 170 to an electronic communication network 822. Electronic communication network 822 may be a collection of one or more wired or wireless networks through which controller 170 is able to communicate with a remote computing device 830. Remote computing device 830 may be a general purpose computer or a portable computing device. Although remote computing device 830 is illustrated as a single computing device, it should be understood that multiple computing devices may be used together, such as over a network or other methods of transferring data. Exemplary computing devices include desktop computers, laptop computers, personal data assistants (“PDA”), such as BLACKBERRY brand devices, cellular devices, tablet computers, or other devices capable of communicating over a network.

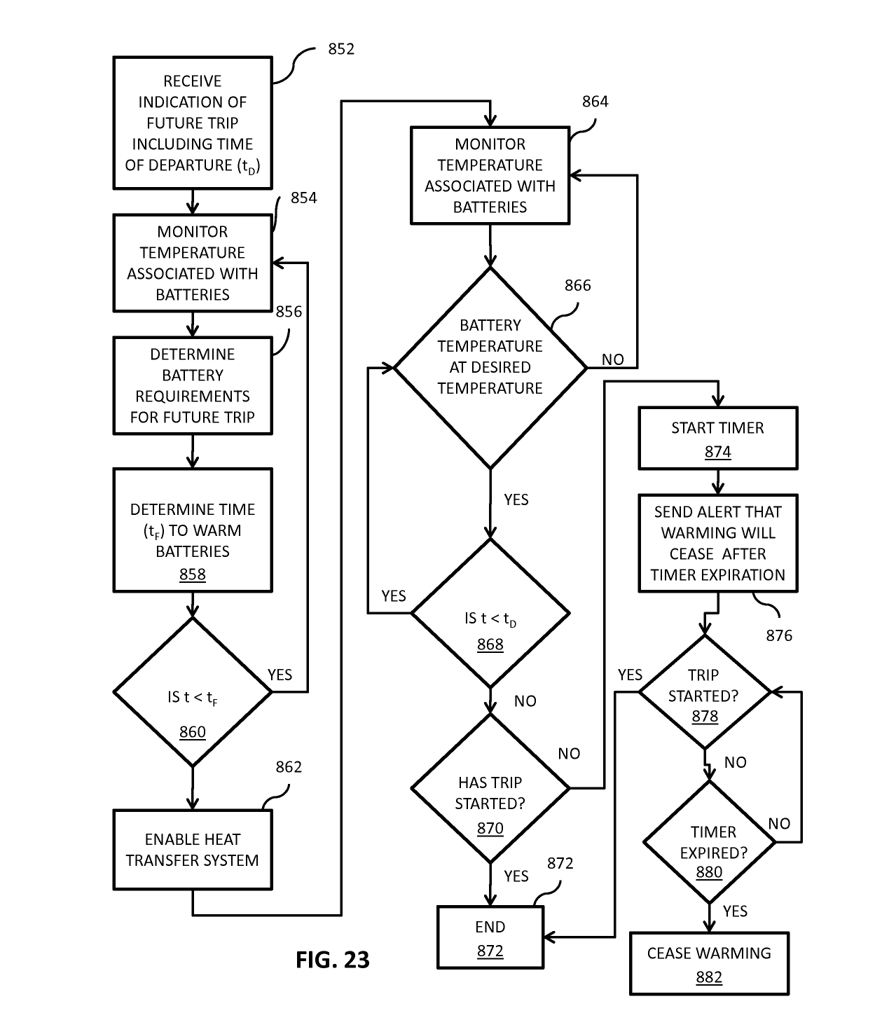

Referring to FIG. 23, an exemplary processing sequence of planning software 812 is illustrated. Controller 170 receives an indication of a future trip including a time of departure (t_{D}) or other indication of the expected occurrence of the future trip, as represented by block 852. Controller 170 monitors the temperature associated with batteries 118 of battery system 114, as represented by block 854.

Planning software 812 determines the battery requirements for the future trip, as represented by block 856. In one example, planning software 812 determines a time (t_{F}) preceding t_{D}, based on the current temperature of batteries 118, a desired temperature of the batteries 118, and the rate of heating provided by fuel cell system 120, that controller 170 should initiate warming of batteries 118 of battery system 114 so that the batteries 118 are warmed at time t_{D}, as represented by block 858. In another example, the operator further provides an indication of a destination or expected range for the future trip. Based on t_{D}, the current temperature of batteries 118, a desired temperature of the batteries 118, the rate of heating provided by fuel cell system 120, and the rate of charging provided by fuel cell system 120, a time (t_{F}) preceding t_{D}, that controller 170 should initiate heating and charging of batteries 118 of battery system 114 is determined. In one instance, the operator specifies an expected range. In another instance, the operator specifies a destination and planning software 812 determines the range based on the current location of vehicle 100. Vehicle 100 would include a GPS system or other location identifying system for this instance. Exemplary designations include address information and other suitable designation identifiers.

Planning software 812 determines if the current time is less than t_{F}, as represented by block 860. If yes, control is returned to block 854 to update the current temperature associated with batteries 118 to take into account any changes in battery temperature. If no, planning software 812 enables the heat transfer system, as represented by block 862. In one embodiment, planning software 812 calls or otherwise initiates battery temperature software 810 to warm or warm and charge batteries 118. Although, battery temperature software 810 and planning software 812 are shown as separate software modules, battery temperature software 810 and planning software 812 may be combined into a single software module. Further, at least portions of battery temperature software 810 and planning software 812 may be implemented as hardware.

Once the warming process has begun, planning software 812 determines if the temperature associated with the batteries 118 is at the desired temperature, as represented by blocks 864 and 866. If not, the warming process continues. If yes, planning software 812 determines if the current time is less than t_{D}, as represented by block 868. If yes, the temperature of batteries 118 is checked again to ensure that batteries 118 are still at the operating temperature.

If no, planning software 812 determines if the trip has started, as represented by block 870. Planning software 812 may determine if the trip has started based on one or more parameters of vehicle 100. An exemplary parameter would be an indication that vehicle 100 has moved since the receipt of the indication of the future trip. If the trip has started, planning software 812 is ended for the current future trip, as represented by block 872. If the trip has not started, planning software 812 continues to monitor the batteries 118 for needed warming and begins a timer, as represented by block 874. The timer prevents planning software 812 from warming batteries 118 for an indefinite duration when the trip may have been canceled. Planning software 812 sends an alert to the operator that warming of the batteries will cease after the timer expires, as represented by block 876. In one embodiment, the alert is sent to one or more remote computing devices 830 associated with the operator. Planning software 812 determines if the trip has started based on one or more parameters of vehicle 100, as represented by block 878. An exemplary parameter would be an indication that vehicle 100 has moved since the receipt of the indication of the future trip. If the trip has started, planning software 812 is ended for the current future trip, as represented by block 872. If the trip has not started, planning software 812 checks to see if the timer has expired, as represented by block 880. If no, control is returned to block 878. If yes, the warming of batteries 118 is ceased, as represented by block 882.

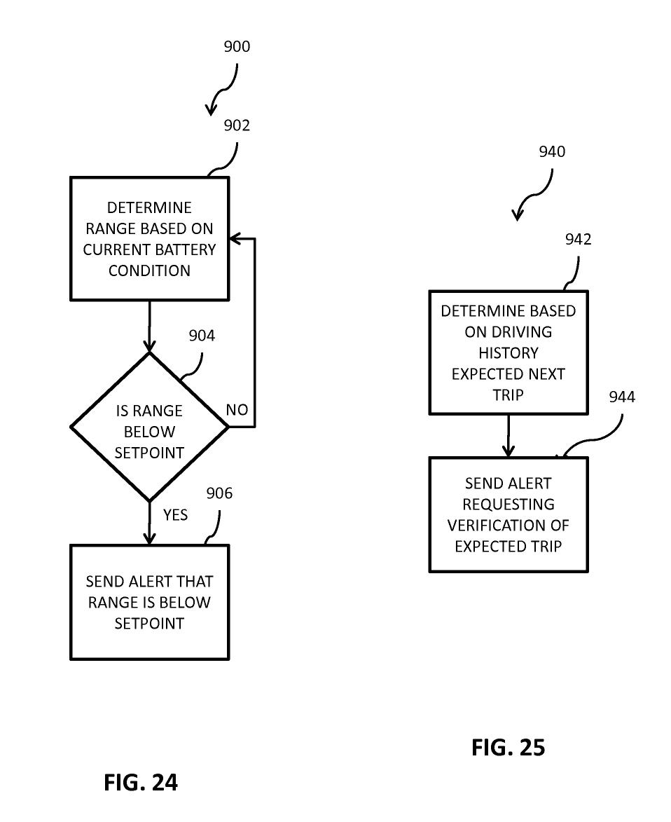

Referring to FIG. 24, another exemplary processing sequence 900 of planning software 812 is illustrated. Planning software 812 determines a range of batteries 118 based on the current battery condition of batteries 118, as represented by block 902. In one example, the range is the expected range when the batteries 118 are warmed to the operating temperature. Planning software 812 determines if the range is below a setpoint range, as represented by block 904. In one example, the operator may specify the setpoint range through operator interface 800. If the range is below the setpoint range, planning software 812 sends an alert to the operator that the range is below the setpoint range, as represented by block 906. In one embodiment, the alert is sent to one or more remote computing devices 830 associated with the operator. The operator may decide to warm and charge the batteries by providing an indication to controller 170 of a future trip which will initiate processing sequence 850.

Referring to FIG. 25, a processing sequence 940 of planning software 812 is illustrated. Planning software 812 determines based on driving history of vehicle 100 an expected next trip for vehicle 100, as represented by block 942. In one embodiment, controller 170 maintains in memory 172 a database of past driving patterns for vehicle 100 and includes a neural network or other predictive modeling routines which predict future trips based on past driving patterns. For example, the past driving patterns may indicate that on weekdays vehicle 100 is typically driven at 6:00 pm. Since today is a weekday, planning software 812 may determine that an expected trip is today at 6:00 pm. In response, planning software 812 sends an alert to the operator requesting verification of the determined expected trip, as represented by block 944. In one embodiment, the alert is sent to one or more remote computing devices 830 associated with the operator. The operator may verify the trip by providing an indication to controller 170 of a future trip which will initiate processing sequence 850.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A vehicle, comprising:
a plurality of ground engaging members;
a frame supported by the plurality of ground engaging members;
a battery system including a plurality of batteries supported by the frame;
a fuel cell system supported by the frame;
a vehicle propulsion system supported by the plurality of ground engaging members, the vehicle propulsion system coupling the battery system to at least one of the plurality of ground engaging members; and
a heat transfer system supported by the frame, the heat transfer system transferring heat produced by the fuel cell system to the battery system to warm the plurality of batteries when a temperature of the plurality of batteries is below a desired temperature.

2. The vehicle of claim 1, further comprising:
at least one temperature sensor monitoring a temperature associated with the plurality of batteries; and
a controller operatively coupled to the heat transfer system, the controller controlling the transfer of heat produced by the fuel cell system to the battery system based at least on the temperature associated with the plurality of batteries and the desired temperature of the plurality of batteries.

3. The vehicle of claim 2, wherein the fuel cell system includes a stacked fuel cell having a first voltage and the plurality of batteries having a second voltage, wherein the controller operatively electrically couples the fuel cell system and the battery system so that the first voltage of the fuel cell stack is generally equal to the second voltage of the plurality of batteries, the heat transfer system transferring heat from the fuel cell system to the plurality of batteries while the first voltage of the fuel cell stack is generally equal to the second voltage of the plurality of batteries.

4. The vehicle of claim 2, wherein the fuel cell system includes a fuel cell stack and a fuel combustor, the fuel cell combustor producing a heated effluent by processing exhaust of the fuel cell stack, the heat transfer system warming the batteries with the heated effluent.

5. The vehicle of claim 4, wherein the heat transfer system warms the fuel cell stack with the heated effluent.

6. The vehicle of claim 4, wherein the heat transfer system includes a blower which is controlled by the controller to control a temperature of the heated effluent.

7. The vehicle of claim 4, wherein the fuel combustor is spaced apart from the battery system.

8. The vehicle of claim 1, wherein the heat transfer system transfers heat from the fuel cell system to the battery system by conduction.

9. The vehicle of claim 1, wherein the heat transfer system is a passive system.

10. The vehicle of claim 9, wherein the heat transfer system includes a housing which is thermally coupled to the fuel cell system and the battery system, a working fluid is provided within the housing, and a wicking material is provided within the housing, wherein when a temperature of the working fluid is at least about equal to the desired temperature of the plurality of batteries the working fluid is in a gaseous state and when the temperature of the working fluid is less than about the desired temperature of the plurality of batteries the working fluid changes to a non-gaseous phase.

11. The vehicle of claim 1, wherein the heat transfer system includes a first heat transfer system having a first heat transfer fluid which transfers heat from the fuel cell system to the battery system and a second heat transfer system having a second heat transfer fluid which transfers heat from the fuel cell system to the battery system independent of the first heat transfer fluid of the first heat transfer system.

12. The vehicle of claim 11, wherein the first heat transfer system is an open system and the second heat transfer system is a closed system.

13. The vehicle of claim 12, wherein the first heat transfer fluid includes a heated effluent produced by a fuel combustor of the fuel cell system.

14. The vehicle of claim 11, wherein both the first heat transfer system and the second heat transfer system are one of open systems and closed systems.

15. The vehicle of claim 1, wherein the plurality of batteries are lithium ion batteries and the desired temperature is in the range from about 25° C. to about 50° C.

16. The vehicle of claim 1, wherein the plurality of batteries are molten salt batteries and the desired temperature is in the range from about 250° C. to about 700° C.

17. The vehicle of claim 2, wherein the controller further controls the transfer of heat produced by the fuel cell system to the battery system based on a received indication of a time of a future trip.

18. The vehicle of claim 17, wherein the controller further controls a charge of the plurality of batteries based on the received indication of the future trip.

19. A method for controlling a temperature of a plurality of batteries, the method comprising the steps of:
monitoring a temperature associated with the plurality of batteries; and
transferring heat from a fuel cell system to the plurality of batteries when a temperature of the plurality of batteries is below a desired temperature.

20. A method for controlling a temperature of a plurality of batteries, the method comprising the steps of:
receiving an indication of a future use;
monitoring a temperature associated with the plurality of batteries;
determining a time period in advance of the future use needed to warm the plurality of batteries to a desired temperature; and
during the time period transferring heat to the plurality of batteries to warm the plurality of batteries while the temperature of the plurality of batteries is below the desired temperature.
